(19) United States
(12) Patent Application Publication
(10) Pub. No.: US 2024/0007186 A1
(43) Pub. Date: Jan. 4, 2024

(54) TURBULENCE-RESILIENT SELF-COHERENT FREE-SPACE OPTICAL COMMUNICATIONS USING AUTOMATIC PILOT-ASSISTED OPTOELECTRONIC BEAM MIXING OF MANY MODES

(71) Applicant: UNIVERSITY OF SOUTHERN CALIFORNIA, Los Angeles, CA (US)

(72) Inventors: Runzhou Zhang, Los Angeles, CA (US); Nanzhe Hu, Los Angeles, CA (US); Alan E. Willner, Los Angeles, CA (US); Huibin Zhou, Los Angeles, CA (US); Haoqian Song, Los Angeles, CA (US); Hao Song, Los Angeles, CA (US); Xinzhou Su, Los Angeles, CA (US); Kaiheng Zou, Los Angeles, CA (US)

(73) Assignee: UNIVERSITY OF SOUTHERN CALIFORNIA, Los Angeles, CA (US)

(21) Appl. No.: 18/267,731

(22) PCT Filed: Jan. 20, 2022
(86) PCT No.: PCT/US2022/013084

§ 371 Date: Jun. 15, 2023

Related U.S. Application Data
(60) Provisional application No. 63/139,657, filed on Jan. 20, 2021.

(51) Int. Cl. H04B 10/112; H04B 10/61; H04B 10/516

(52) U.S. Cl. CPC H04B 10/1121; H04B 10/615; H04B 10/5161

(57) ABSTRACT

Atmospheric turbulence degrades decoding and data recovery from optically transmitted signals. For example, atmospheric turbulence can induce power coupling from the transmitted Gaussian mode to higher-order modes, resulting in significantly degraded mixing efficiency and system performance. Systems and methods are provided to generate a signal that is a conjugate of the atmospheric noise which is combined with a received data signal to ameliorate atmospheric noise. An optical pilot beam may be transmitted with an optical data beam and received by a receiver which utilizes the optical pilot beam to generate the signal that is a conjugate of the atmospheric noise.

### CROSS-REFERENCE TO RELATED APPLICATIONS

This application is based upon and claims priority to U.S. provisional patent application 63/139,657 entitled “TURBULENCE-RESILIENT COHERENT FREE-SPACE OPTICAL COMMUNICATIONS USING AUTOMATIC POWER-EFFICIENT PILOT-ASSISTED OPTOELECTRONIC BEAM MIXING OF MANY MODES” and filed on Jan. 20, 2021, the entire content of which is incorporated herein by reference.

### STATEMENT AS TO FEDERALLY SPONSORED RESEARCH

This invention was made with government support under contract numbers N00014-16-1-2813, N00014-20-1-2558 and N00014-17-2-2443 awarded by the Office of Naval Research (ONR), contract number 4441006051 awarded by the Defense Security Cooperation Agency, contract number FA9550-20-1-0152 awarded by the DOD Defense University Research Instrumentation Program (DURIP), and contract number N6600120C4704 awarded by the Naval Information Warfare Center Pacific. The government has certain rights in this invention.

### BACKGROUND

### 1. Field

This disclosure relates generally to optical communication, and more specifically, to turbulence-resilient self-coherent free-space optical communications.

### 2. Description of the Related Art

In free-space optical (FSO) communications employing both amplitude and phase data modulation (e.g., quadrature-amplitude-modulation (QAM)), data is typically recovered by mixing a Gaussian local oscillator (LO) with a received Gaussian data beam. However, atmospheric turbulence can induce power coupling from the transmitted Gaussian mode to higher-order modes, resulting in significantly degraded mixing efficiency and system performance. Thus, there is a need for improved mixing efficiency and system performance to ameliorate the deleterious effects of atmospheric turbulence.

### SUMMARY

A method is provided for free space optical (FSO) communication. In various embodiments, the method includes transmitting, by a transmitter, an optical beam containing data and an optical pilot beam. The optical data beam and the optical pilot beam may be transmitted over free space. The method may include receiving, by at least one photodetector, the optical data beam and the optical pilot beam. The method may further include compensating for optical distortions (e.g., atmospheric noise and/or transmitter/receiver misalignments) between the transmitter and the at least one photodetector using a conjugate of the received optical pilot beam.

In various instances, the optical pilot beam is transmitted coaxially with the optical data beam. The optical pilot beam may be used as a local oscillator. A frequency difference between the optical data beam and the optical pilot beam may be orders of magnitude smaller than carrier frequencies of the optical data beam and the optical pilot beam. The optical pilot beam may be a continuous wave signal. Compensating for the optical distortions (e.g., atmospheric noise and/or transmitter/receiver misalignments) may include mixing each Laguerre-Gaussian component of the optical data beam with a corresponding conjugate Laguerre-Gaussian component of the optical pilot beam. Moreover, it may be assumed that the optical pilot beam experiences similar turbulence as the optical data beam. In various embodiments, the at least one photodetector comprises an array of multiple photodetector elements.

A system for free space optical (FSO) communications is disclosed. The system may include a transmitter configured to transmit an optical data beam containing data and an optical pilot beam, the optical data beam and the optical pilot beam being transmitted over free space. The system may include at least one photodetector configured to receive the optical data beam and the optical pilot beam. The system may include a processor connected to the at least one photodetector and configured to compensate for optical distortions (e.g., atmospheric noise and/or transmitter/receiver misalignments) between the transmitter and the at least one photodetector by using a conjugate of the received optical pilot beam to cancel distortions in the received optical data beam.

In various embodiments of the system, the optical pilot beam is transmitted coaxially with the optical data beam. The optical pilot beam may be used as a local oscillator. A frequency difference between the optical data beam and the optical pilot beam may be orders of magnitude smaller than carrier frequencies of the optical data beam and the optical pilot beam. The optical pilot beam may be a continuous wave signal. Compensating for the optical distortions (e.g., atmospheric noise and/or transmitter/receiver misalignments) may include mixing each Laguerre-Gaussian component of the optical data beam with a corresponding conjugate Laguerre-Gaussian component of the optical pilot beam. Moreover, it may be assumed that the optical pilot beam experiences similar turbulence as the optical data beam. In various embodiments, the at least one photodetector comprises an array of multiple photodetector elements.

A further system for free space optical (FSO) communications is disclosed. The system may have at least one photodetector configured to receive an optical data beam containing data and an optical pilot beam, the optical data beam and the optical pilot beam having traveled through free space. The system may have a processor connected to the at least one photodetector and configured to compensate for optical distortions (e.g., atmospheric noise and/or transmitter/receiver misalignments) introduced in the free space by using a conjugate of the received optical pilot beam to cancel distortions in the received optical data beam.

In various embodiments of the further system, there may also be a transmitter configured to transmit the optical data beam and the optical pilot. The optical pilot beam may be transmitted coaxially with the optical data beam. The optical pilot beam may be used as a local oscillator. A frequency difference between the optical data beam and the optical pilot beam may be orders of magnitude smaller than carrier frequencies of the optical data beam and the optical pilot beam. The optical pilot beam may be a continuous wave signal. Moreover, compensating for the optical distortions (e.g., atmospheric noise and/or transmitter/receiver misalignments) includes mixing each Laguerre-Gaussian component of the optical data beam with a corresponding conjugate Laguerre-Gaussian component of the optical pilot beam. In various embodiments, the at least one photodetector comprises an array of multiple photodetector elements.

### BRIEF DESCRIPTION OF THE DRAWINGS

Other systems, methods, features, and advantages of the present invention will be or will become apparent to one of ordinary skill in the art upon examination of the following figures and detailed description.

FIG. 1 depicts a system for free-space optical communication, in accordance with various embodiments;

FIG. 2 depicts a method for free-space optical communication, in accordance with various embodiments;

FIG. 3A-B illustrates optical power losses associated with free-space optical communication, in accordance with various embodiments;

FIG. 3C-D illustrates electrical mixing power losses associated with free-space optical communication, in accordance with various embodiments;

FIG. 3E illustrates results of a simulation of the system using 1-random phase screen (1-RPS); in accordance with various embodiments;

FIG. 4A shows a measured bit-error-rate for X-polarization signals under weaker turbulence, in accordance with various embodiments;

FIG. 4B shows a measured bit-error-rate for Y-polarization signals under weaker turbulence, in accordance with various embodiments;

FIG. 4C shows a measured bit-error-rate for X-polarization signals under stronger turbulence, in accordance with various embodiments;

FIG. 4D shows a measured bit-error-rate for Y-polarization signals under stronger turbulence, in accordance with various embodiments;

FIG. 5A shows a chart of normalized optical power for various angular misalignments, in accordance with various embodiments;

FIG. 5B shows a chart of normalized optical power for various lateral misalignments, in accordance with various embodiments;

FIG. 5C shows a chart of normalized electrical mixing power for various angular misalignments, in accordance with various embodiments;

FIG. 5D shows a chart of normalized electrical mixing power for various lateral misalignments, in accordance with various embodiments;

FIG. 5E depicts a chart of bit error rate (BER) for various lateral misalignments, in accordance with various embodiments;

FIG. 5F depicts a chart of bit error rate (BER) for various angular misalignments, in accordance with various embodiments;

FIG. 6A shows a chart of measured mixing power losses, in accordance with various embodiments;

FIG. 6B shows a chart of Q factor degradation for random turbulence realizations, in accordance with various embodiments;

FIG. 7 shows a chart of different relative sizes and configurations of photodetectors, in accordance with various embodiments;

FIG. 8A depicts an electrical spectrum shown as a chart of normalized power (dB) vs electrical frequency (GHz) for a LO-based heterodyne coherent receiver with no interference as well as the recovered 16-QAM data constellation, in accordance with various embodiments;

FIG. 8B depicts an electrical spectrum shown as a chart of normalized power (dB) vs electrical frequency (GHz) for a LO-based heterodyne coherent receiver with interference as well as the recovered 16-QAM data constellation, in accordance with various embodiments;

FIG. 9A depicts an electrical spectrum shown as a chart of normalized power (dB) vs electrical frequency (GHz) for a pilot-assisted self-coherent PD array receiver with no interference as well as the recovered 16-QAM data constellation, in accordance with various embodiments;

FIG. 9B depicts an electrical spectrum shown as a chart of normalized power vs electrical frequency for a pilot-assisted self-coherent PD array receiver with interference as well as the recovered 16-QAM data constellation, in accordance with various embodiments;

FIG. 10 depicts a chart that shows the measured BERs for the LO-based heterodyne coherent detector and for the pilot-assisted self-coherent PD array detector under 100 turbulence realizations, in accordance with various embodiments;

FIG. 11A shows, for a scenario without turbulence and using a PD having an array of smaller PD elements, an electrical spectrum for 0.5-Gbaud 16-QAM and the recovered 16-QAM data constellation, an electrical spectrum for 1-Gbaud 16-QAM and the recovered 16-QAM data constellation, and an electrical spectrum for 1.5-Gbaud 16-QAM and the recovered 16-QAM data constellation in accordance with various embodiments;

FIG. 11B shows, for a scenario without turbulence and using a PD having a single larger PD elements, an electrical spectrum for 0.5-Gbaud 16-QAM and the recovered 16-QAM data constellation, an electrical spectrum for 1-Gbaud 16-QAM and the recovered 16-QAM data constellation, and an electrical spectrum for 1.5-Gbaud 16-QAM and the recovered 16-QAM data constellation, in accordance with various embodiments;

FIG. 11C shows, for a scenario without turbulence and using a PD having a single smaller PD element, an electrical spectrum for 0.5-Gbaud 16-QAM and the recovered 16-QAM data constellation, an electrical spectrum for 1-Gbaud 16-QAM and the recovered 16-QAM data constellation, and an electrical spectrum for 1.5-Gbaud 16-QAM and the recovered 16-QAM data constellation, in accordance with various embodiments;

FIG. 12A shows, for a scenario with turbulence and using a PD having an array of smaller PD elements, an electrical spectrum for 0.5-Gbaud 16-QAM and the recovered 16-QAM data constellation, an electrical spectrum for 1-Gbaud 16-QAM and the recovered 16-QAM data constellation, and an electrical spectrum for 1.5-Gbaud 16-QAM and the recovered 16-QAM data constellation, in accordance with various embodiments;

FIG. 12B shows, for a scenario with turbulence and using a PD having a single larger PD elements, an electrical spectrum for 0.5-Gbaud 16-QAM and the recovered 16-QAM data constellation, an electrical spectrum for 1-Gbaud 16-QAM and the recovered 16-QAM data constellation, and an electrical spectrum for 1.5-Gbaud 16-QAM and the recovered 16-QAM data constellation, in accordance with various embodiments; and

FIG. 12C shows, for a scenario with turbulence and using a PD having a single smaller PD element, an electrical spectrum for 0.5-Gbaud 16-QAM and the recovered 16-QAM data constellation, an electrical spectrum for 1-Gbaud 16-QAM and the recovered 16-QAM data constellation, and an electrical spectrum for 1.5-Gbaud 16-QAM and the recovered 16-QAM data constellation, in accordance with various embodiments.

### DETAILED DESCRIPTION

As disclosed herein, systems and methods may utilize a pilot-assisted self-coherent detection approach to overcome the deleterious effects of atmospheric turbulence in free-space optical communications employing both amplitude and phase data modulation. Specifically, systems and methods may include transmitting both a Gaussian data beam and a frequency-offset Gaussian pilot tone beam, such that both beams experience similar turbulence and modal coupling. Subsequently, a photodetector (PD) mixes all corresponding pairs of the beams' modes. During mixing, a conjugate of the turbulence-induced modal coupling is generated and compensates the modal coupling experienced by the data, and thus corresponding modes of the pilot and data efficiently mix. In this disclosure, it is demonstrated that 12-Gbit/s 16-QAM polarization-multiplexed FSO link is resistant to turbulence.

Compared to radio, FSO communications has gained significant interest due to higher data capacity and lower probability of interception. Often, an amplitude-only-modulated (e.g., pulse-amplitude-modulation (PAM)) Gaussian data beam is transmitted and recovered. Since data is encoded as distinct amplitude levels, the data constellation points of PAM lie on a 1-dimensional line in the 2-dimensional in-phase (I) and quadrature (Q) constellation. Alternatively, FSO systems can benefit from recovering amplitude and phase of the data beam to enable complex modulation formats, such as QAM. Since data is encoded as distinct vectors, QAM I/Q constellation points can be arranged in a 2-dimensional array. In comparison to PAM of the same number of constellation points (i.e., modulation order) and average power per bit, QAM is generally less demanding in terms of optical signal-to-noise ratio (OSNR) of the transmitted data due to its larger Euclidean distance in the 2-dimensional I/Q constellation. This advantage tends to be more pronounced as the modulation order increases. Additionally, phase recovery can enable various digital-signal-processing (DSP) functions, which might benefit future FSO systems (e.g., compensation for hybrid fiber/FSO systems and adaptive-probabilistic-shaped modulations).

Intensity modulation/direct detection (IM/DD) FSO links typically receive amplitude-encoded data by directly detecting the beam's intensity levels, yet phase information is not readily recovered. Alternatively, FSO systems can recover both amplitude and phase by using coherent detection, which mixes the data beam with a receiver Gaussian LO beam. However, atmospheric turbulence generally limits coherent detection because it induces power coupling of the data beam from the Gaussian mode to other Laguerre-Gaussian (LG) spatial modes. Such turbulence-induced modal coupling can significantly degrade the LO-data mixing efficiency due to “mode mismatch” between the LO and data beams. Without turbulence, the PD efficiently mixes the data and LO since they typically occupy the same single Gaussian mode, hence “mode matched” in their spatial distributions. With turbulence, however, significant power of the data beam can be coupled into higher-order LG modes and degrade mixing efficiency by >20 dB, since data power coupled to orthogonal higher-order modes does not efficiently mix with the Gaussian LO.

To enable amplitude and phase recovery in turbulent links, various modal-coupling mitigation approaches have been demonstrated. One technique employs adaptive optics to couple data power back into the Gaussian mode by measuring distortion using a wavefront sensor and applying a DSP-calculated conjugate phase to the beam by a wavefront corrector. Another technique employs multi-mode digital coherent combining, wherein much of the data power in higher-order modes is captured by either a multi-mode fiber or an array of single-mode-fiber (SMF) apertures. Subsequently, the power from each of multiple modes is recovered by a separate coherent detector and combined using DSP. The performance depends on the number of recovered modes, and the detection-system complexity tends to increase with the number of detected modes. Since turbulence may induce coupling to a large number of modes, one implementation to achieve simultaneous amplitude and phase recovery would be to automatically compensate for such power coupling without additional data processing and do so in a single element that efficiently scales to recover all captured modes.

This disclosure elaborates on experimentally proven near-error-free transmission of a 12-Gbit/s 16-QAM polarization-multiplexed (PolM) FSO link that is resilient to turbulence-induced LG modal power coupling for 200 random turbulence realizations. The amplitude and phase of the transmitted QAM data is retrieved by using a pilot-assisted self-coherent detector. In various embodiments, a Gaussian pilot beam is transmitted with a frequency offset from the Gaussian data beam, such that both beams experience similar turbulence-induced LG modal coupling. Subsequently, a single free-space-coupled PD mixes the received multi-mode data beam with the multi-mode pilot beam in “self-coherent” detection. During mixing, a conjugate of the turbulence-induced modal coupling of the pilot beam is automatically generated and used to compensate for the modal coupling in the data beam. Specifically, each data-pilot LG modal pair efficiently mixes and contributes to the intermediate-frequency (IF) signal. Since the data and pilot experience similar modal coupling, this approach can simultaneously mix and recover nearly all the captured data modes using a single PD. Experimental results for turbulence strength (i.e., ratio of beam size over the Fried parameter) 2w₀/r₀˜5.5 show an average mixing loss of ˜3.3 dB.

The following discussion includes the results of a various demonstrations of various embodiments. For example, various embodiments may contemplate pilot-assisted self-coherent detection using optoelectronic mixing. In an FSO link, a fundamental Gaussian beam (i.e., LG_{0,0}(x,y)) carrying a data channel (denoted as S(t,f) with carrier frequency f) is transmitted through turbulent atmosphere. Due to a random spatial and temporal refractive-index distribution, the turbulence effects can induce transverse, spatially dependent wavefront distortion to the Gaussian beam. Moreover, since such distortion induces modal power coupling, the electrical field of the data beam (E data) at the receiver aperture can be expressed as a superposition of LG modes:

E_{data}(t,f,x,y)=S(t,f)·U(x,y)=S(t,f)·ΣₗΣₚa_{l,p}·LG_{l,p}(x,y),

where LG_{l,p}(x,y) represents the electrical field of the LG modes with an azimuthal index 1 and a radial index p; a_{l,p}=∫∫U(x,y)·LG_{l,p}(x,y)dxdy is the complex coefficient of the corresponding LG_{l,p} component in the wavefront, * denotes the conjugate of the modal electrical field, and the portion of optical power coupled to the LG_{l,p} mode is |a_{l,p}|²; and U(x,y)=ΣₗΣₚa_{l,p}·LG_{l,p}(x,y) represents the turbulence-induced LG modal coupling. Ideally, the complex weights a_{l,p} for all modal components tend to satisfy ΣₗΣₚ|a_{l,p}|²≅1 if the receiver aperture can collect almost the entire beam.

A turbulent IM/DD FSO link (i.e., S(t,t) is amplitude-only encoded) may suffer from turbulence-induced modal-coupling loss if an SMF-coupled PD is utilized because higher-order modes are not efficiently captured by the SMF. For a free-space coupled PD, however, an IM/DD FSO link may not be significantly affected by modal coupling if the receiver aperture can collect most of the distorted beam. This free-space PD can utilize the detected optical intensity (i.e., |S(t,f|²) to recover the amplitude-encoded data, but the beam's phase information is not readily recoverable.

Traditional coherent-detection FSO links can recover both amplitude and phase but suffer from performance degradation caused by turbulence-induced modal coupling. For instance, a transmitted data S(t,t) contains both amplitude and phase-encoded data (e.g., 16-QAM). By way of a simple illustrative example, a LO at a receiver in a single-PD heterodyne coherent detector has an optical frequency offset M from the data carrier and is a continuous-wave (CW) Gaussian beam (C(f—Δf)·LG_{0,0}(x,y)). The square-law mixing in the PD of the coherent receiver results in photocurrent:

$$I ∝ \int \int {\vert C ( f - Δ f ) \cdot {LG}_{0 , 0} ( x , y ) + S ( t , f ) \cdot U ( x , y ) \vert}^{2} dxdy = {\vert C ( f - Δ f ) \vert}^{2} + {\vert S ( t , f ) \vert}^{2} + 2 Re [ S ( t , f ) \cdot {C}^{*} ( f - Δ f ) ] \cdot \int \int U ( x , y ) \cdot {LG}_{0 , 0}^{*} ( x , y ) \qquad ( 2 )$$

where Re [·] is the real part of a complex element; I is the generated photocurrent; IC(f−Δf)|² and |S(t,f)|² are the direct current (DC) and signal-signal-beating-interference (SSBI) photocurrent, respectively; and 2Re [S(t,f)·C*(f−Δf)] generates the desired signal-LO-beating (SLB) photocurrent. However, the Gaussian-mode LO does not efficiently mix with the multiple-LG-mode data beam due to the mode mismatch between their LG spectra, expressed as:

∫∫U(x,y)·LG_{0,0}(x,y)dxdy=∫∫ΣₗΣₚa_{l,p}·LG_{l,p}(x,y)·LG*_{0,0}(x,y)dxdy=a_{0,0}

where orthogonality among LG modes ensures that ∫∫LG_{0,0}(x,y)·LG_{0,0}(x,y)dxdy=1 and ∫∫LG_{l,p}(x,y)·LG_{0,0}(x,y)dxdy=0, given that l≠0 or p≠0. Equation (3) shows that only the portion of the transmitted power that remains LG_{0,0} after turbulence can be efficiently mixed with the LO and utilized for recovering QAM data. Such modal-coupling loss can result in severe degradation of the mixing IF power and thus the recovered data quality. We note that this mixing-efficiency degradation in coherent detection can occur for a PD that is: (i) free-space-coupled due to orthogonality between the higher-order modes and the Gaussian LO, and (ii) SMF-coupled due to power in the higher-order modes not being efficiently coupled into the fiber.

The performance of coherent detection can be significantly degraded by the turbulence-induced LG-modal-coupling effects. A fundamental Gaussian beam (i.e., LG_{0,0} mode) carrying a 16-QAM data is transmitted through turbulent atmosphere. Due to the turbulence-induced LG modal power coupling, the received data beam would contain many LG modes. In an LO-based heterodyne coherent detector, only the LG_{0,0} mode can be efficiently mixed with the LO and recovered, resulting in recovered data quality degradation. This is true for both free-space/SMF-coupled PD since the LO is typically single-Gaussian-mode.

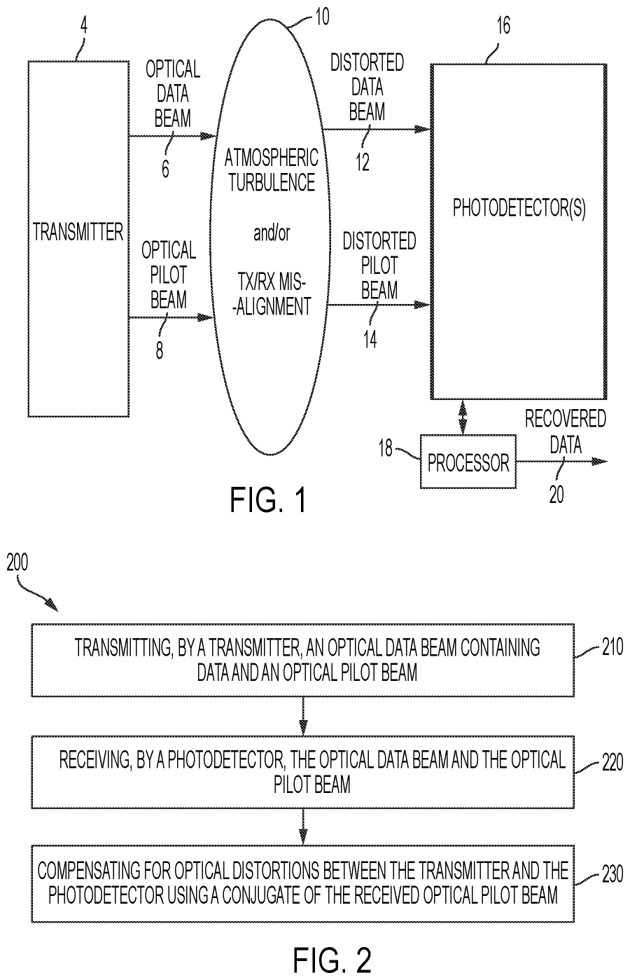

With reference to FIG. 1, a system for free space optical (FSO) communication 2 may implement pilot-assisted self-coherent detection to automatically compensate for the turbulence-induced LG-modal-coupling effects. In the pilot-assisted self-coherent detector, the transmitter 4 transmits an additional CW pilot beam which experiences similar turbulence-induced LG coupling as the data beam. During optoelectronic mixing of the pilot and data beams in a square-law detector, a conjugate of the turbulence experienced by the pilot is automatically generated and compensates the turbulence experienced by the data beam. Therefore, almost all the data LG modes can be efficiently mixed with the pilot to enable simultaneous amplitude and phase recovery of a QAM data.

Thus, in various embodiments, a system for pilot assisted self-coherent detection 2 may include a transmitter 4 that transmits an optical data beam 6 and an optical pilot beam 8. Both of the optical data beam 6 and the optical pilot beam 8 may pass through a signal path that introduces distortions. For instance, the optical data beam 6 and the optical pilot beam 8 may pass through atmospheric turbulence 10. The atmospheric turbulence 10 may distort the optical data beam 6, which, having added distortion, is represented as distorted data beam 12. The atmospheric turbulence 10 may distort the optical pilot beam 8, which, having added distortion, is represented as distorted pilot beam 14. A photodetector 16 may receive both the distorted data beam 12 and the distorted pilot beam 14. The photodetector 16 provides data representative of the distorted data beam 12 and distorted pilot beam 14 to a processor 18. The processor 18 may generate a noise cancelation signal that at least partially cancels the distortions introduced by the atmospheric turbulence 10. For instance, the processor 18 may generate a conjugate signal. The processor 18 may combine the noise cancelation signal with the distorted data beam 12 to ameliorate distortions introduced by the atmospheric turbulence 10 and improve accuracy and precision of reception and decoding of the data in the distorted data beam 12. The processor 18 may then generate recovered data 20 recovered from the distorted data beam 12.

Thus, a system for free space optical (FSO) communications 2 may include a transmitter 4 configured to transmit an optical data beam 6 containing data and an optical pilot beam 8, the optical data beam 6 and the optical pilot beam 8 being transmitted over free space (such as through atmospheric turbulence 10). The atmospheric turbulence may introduce optical distortions (e.g., atmospheric noise and/or transmitter/receiver misalignments) in the optical data beam 6 so that it becomes distorted data beam 12 and into the optical pilot beam 8 so that it becomes distorted pilot beam 14. A photodetector 16 is configured to receive the optical data beam 6 having distortions (distorted data beam 12) and the optical pilot beam 8 having distortions (distorted pilot beam 14). A processor 18 connected to (or as a component of) the photodetector 16 is configured to compensate for optical distortions (e.g., atmospheric noise and/or transmitter/receiver misalignments) between the transmitter 4 and the photodetector 16 by using a conjugate of the received optical pilot beam (distorted pilot beam 14) to cancel distortions in the received optical data beam (distorted data beam 12) and generate recovered data 20.

In various embodiments, the optical pilot beam 8 is transmitted coaxially with the optical data beam 6. Moreover, the optical pilot beam 8 may be used as a local oscillator. A frequency difference between the optical data beam 6 and the optical pilot beam 8 may be orders of magnitude smaller than carrier frequencies of the optical data beam 6 and the optical pilot beam 8. The optical pilot beam 8 may be a continuous wave signal. Furthermore, compensating by the processor 18 for the optical distortions (e.g., atmospheric noise and/or transmitter/receiver misalignments) in the distorted data beam 12 may include mixing each Laguerre-Gaussian component of the optical data beam 6 having distortions (distorted data beam 12) with a corresponding conjugate Laguerre-Gaussian component of the optical pilot beam 8 having distortions (distorted pilot beam 14).

Directing attention to both FIG. 1 and also FIG. 2, a method 200 for free space optical (FSO) communications is also provided. The method may include transmitting, by a transmitter 4, an optical data beam 6 containing data and an optical pilot beam 8, the optical data beam 6 and the optical pilot beam 8 being transmitted over free space (through atmospheric turbulence 10) (block 210). The method may include receiving, by a photodetector 16, the optical data beam 6 having distortions (distorted optical data beam 12) and the optical pilot beam 8 having distortions (distorted optical pilot beam 14) (block 220). The method may include compensating for optical distortions (e.g., atmospheric noise and/or transmitter/receiver misalignments) (atmospheric turbulence 10) between the transmitter 4 and the photodetector 16 (block 230). In various embodiments, the compensating includes using a conjugate of the received optical pilot beam (distorted pilot beam 14) such as by the photodetector 16 and/or the processor 18.

Turning more specifically to FIG. 1, a more detailed discussion follows of one example embodiment of the simultaneous recovery of a QAM data's amplitude and phase by utilizing pilot-assisted self-coherent detection, which automatically compensates for the turbulence-induced modal coupling. In addition to the Gaussian data beam (optical data beam 6), a co-axial Gaussian beam (optical pilot beam 8) is transmitted carrying a CW pilot tone with a frequency offset M, producing a frequency gap between the optical pilot beam 8 and optical data beam 6 of roughly the channel bandwidth (B) to avoid SSBI. The electrical fields of the optical data beam 6 and the optical pilot beam 8 are likely to experience similar turbulence-induced distortion and modal coupling due to their frequency difference being orders of magnitudes smaller than their carrier frequencies. This similar distortion (introduced by atmospheric turbulence 10) produces automatic “mode matching” between the beams, such that the pilot-tone electric field is:

Eₚᵢₗₒₜ(f−Δf,x,y)=C(f−Σf)·U(x,y)=C(f−Δf)·ΣₗΣₚa_{l,p}·LG_{l,p}(x,y).

Importantly, a turbulence-induced LG-coupling conjugate U* (noise cancelation signal 22) is automatically generated from the distorted pilot beam 14 by the processor 18 (and/or photodetector 16) to compensate for the modal coupling experienced by the distorted data beam 12, and the total generated photocurrent is:

$$I ∝ \int \int {\vert C ( f - Δ f ) \cdot U ( x , y ) + S ( t , f ) \cdot U ( x , y ) \vert}^{2} dxdy = {\vert C ( f - Δ f ) \vert}^{2} + {\vert S ( t , f ) \vert}^{2} + 2 Re [ S ( t , f ) \cdot {C}^{*} ( f - Δ f ) ] \cdot \int \int U ( x , y ) \cdot {U}^{*} ( x , y ) dxdy , \qquad ( 5 )$$

where S(t,f)·C*(f−Δf) generates the desired signal-pilot-beating (SPB) photocurrent at an IF of Δf. The modal coupling is (ideally) corrected in an automatic fashion and the mixing efficiency is:

$$Mixing efficiency ∝ \int \int U ( x , y ) \cdot {U}^{*} ( x , y ) dxdy = \int \int {\sum }_{l} {\sum }_{p} {a}_{l , p} \cdot {LG}_{l , p} ( x , y ) \cdot {\sum }_{{l}^{′}} {\sum }_{{p}^{′}} {a}_{{l}^{′} , {p}^{′}}^{*} \cdot {LG}_{{l}^{′} , {p}^{′}}^{*} ( x , y ) dxdy = {\sum }_{l} {\sum }_{p} {\sum }_{{l}^{′}} {\sum }_{{p}^{′}} \int \int {a}_{l , p} \cdot {LG}_{l , p} ( x , y ) \cdot {a}_{{l}^{′} , {p}^{′}}^{*} \cdot {LG}_{{l}^{′} , {p}^{′}}^{*} ( x , y ) dxdy = {\sum }_{l} {\sum }_{p} {\vert {a}_{l , p} \vert}^{2} ≅ 1 , \qquad ( 6 )$$

where each LG_{l,p} component of the data beam is efficiently mixed with the corresponding LG_{l,p} component of the pilot beam. Consequently, almost all the captured optical power carried by higher-order LG spatial modes can contribute to the IF signal and can be automatically recovered using a single square-law PD. The recovered data 24 can thus exhibit resilience to modal-coupling loss due to the efficient mixing between the data and pilot beams.

The pilot-assisted self-coherent approach shares some similarities with both the IM/DD and coherent detection: (i) similar to IM/DD, this approach does not utilize a receiver-based LO; and (ii) similar to coherent detection, this approach recovers amplitude and phase by mixing an “LO-like” transmitter-generated pilot with the data beam, and is often called “self-coherent detection.” Notably, the pilot in the self-coherent system would experience similar FSO channel loss as the data beam, which may be significant in longer-distance FSO links, whereas the LO in coherent detection would not.

Generally, the required OSNR to achieve a desired bit-error-rate (BER) depends on both the modulation formats and detection approaches. When comparing self-coherent to heterodyne coherent for amplitude and phase encoded data, the transmitted power of self-coherent is shared between the pilot and data beams, resulting in self-coherent being more OSNR-demanding as compared to coherent detection (without turbulence effects). For example, to achieve a given BER for the same QAM order, a self-coherent approach is likely to require ˜3-dB higher OSNR when the carrier (i.e., pilot)-to-signal power ratio (CSPR) is ˜1 as compared to heterodyne coherent detection. When comparing the amplitude-and-phase self-coherent approach to amplitude-only IM/DD, the OSNR advantage of self-coherent QAM over IM/DD PAM (with the same modulation order) becomes more significant as the modulation order increases (e.g., conventionally regarded to be many dB for ≥16-QAM).

In longer-distance FSO links, the required optical power per bit for a desired BER can be a limiting factor. Since the transmitted power is shared between the pilot and data beams, self-coherent is likely to have a lower SNR as compared to free-space-coupled IM/DD with the same received optical power and receiver thermal noise. Moreover, the SNR advantage of QAM over PAM diminishes as the modulation order decreases. Consequently, IM/DD may have better BER performance than pilot-assisted self-coherent for low modulation orders, such as 2-PAM. One may also note that IM/DD may have better performance than self-coherent detection under lower SNR conditions even at higher modulation formats.

Moreover, since atmospheric turbulence tends not to induce significant depolarization effects, the pilot-assisted system should be compatible with PolM techniques by transmitting pilot-data pairs on each orthogonal polarization.

The provided approach transmits a pilot along with the data, and the pilot serves to help probe the turbulence and create a conjugate of the distortion from modal coupling. In optical communications, pilot-assisted techniques have been demonstrated to probe a channel's signature and apply a conjugate of that signature to help mitigate various channel impairments, including cross phase modulation and laser phase noise. More specifically, it has been shown via simulation that turbulence-induced modal crosstalk can be reduced by mixing a pilot beam and data-carrying LG beams in a mode-division-multiplexed FSO link. In that approach, the pilot acquires the turbulence signature, is split into multiple copies at receiver, and generates a conjugate of turbulence for each LG data beams in separate PDs.

Embodiments disclosed herein may include an experimental setup of FSO communications with emulated turbulence. This disclosure also experimentally demonstrates pilot-assisted self-coherent detection in a 12-Gbit/s PolM 16-QAM 1-meter FSO link with emulated turbulence. The strengths (i.e., ratio of beam size 2w₀ over the Fried parameter r₀) of weaker and stronger turbulence effects are 2w₀/r₀˜2.2 and 5.5, respectively.

The experimental setup emulates atmospheric turbulence effects using a single rotatable phase plate. Generally, turbulence effects can be more-accurately emulated using multiple phase plates. To address emulation accuracy, the experimental setup simulates the optical and electrical mixing power loss using single and multiple random phase screen (RPS) models. The simulation results show similar loss distributions and trends for both 1-RPS and models.

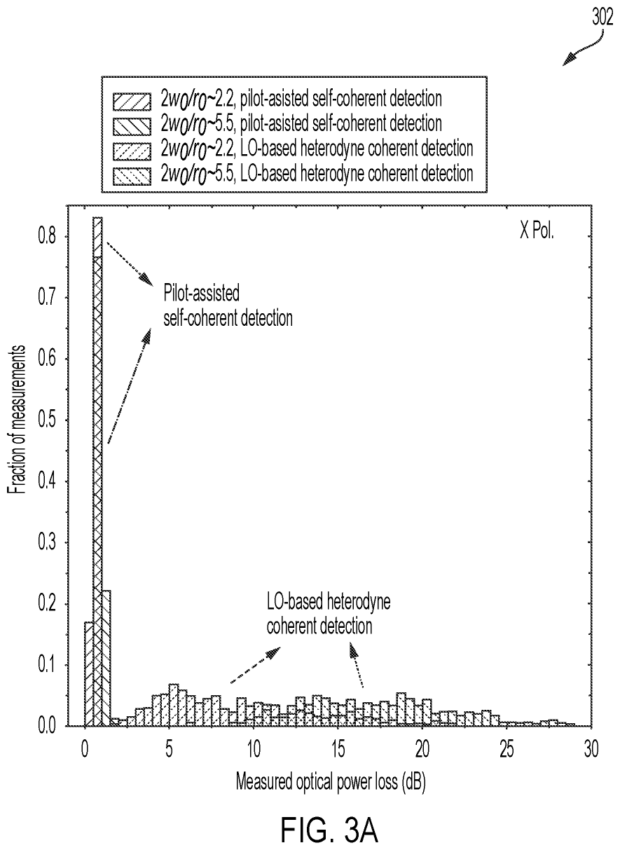

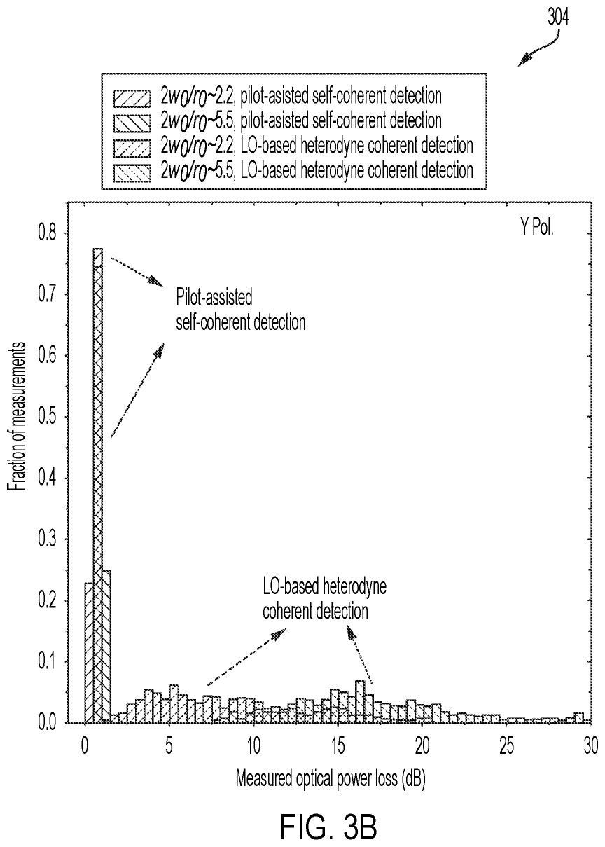

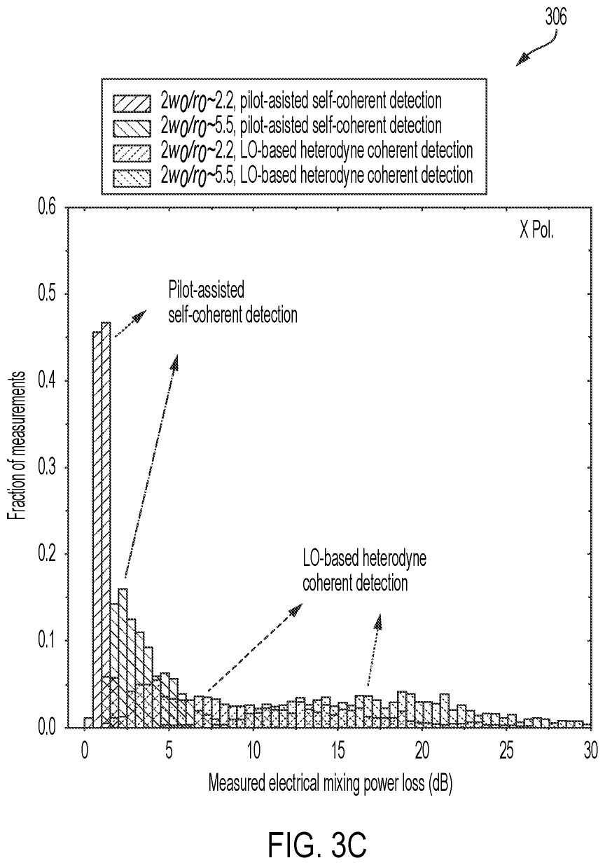

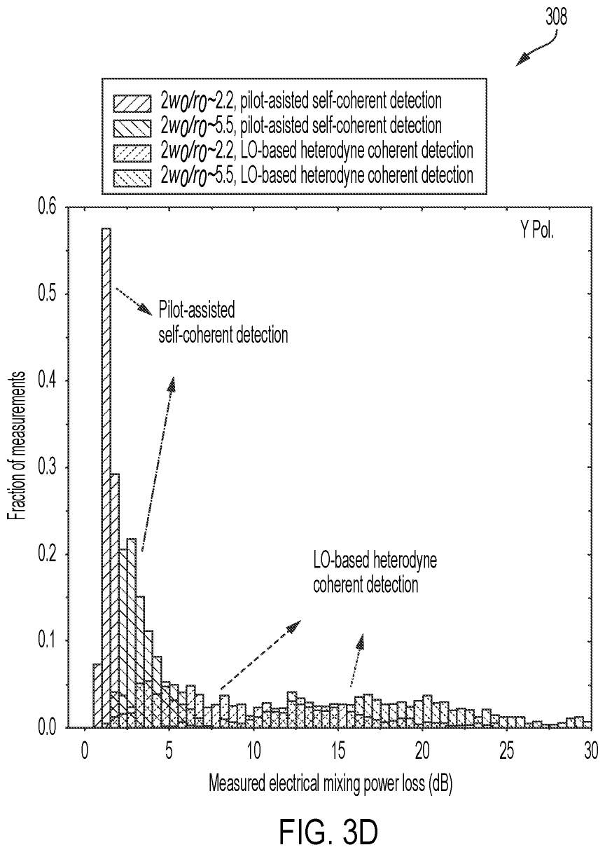

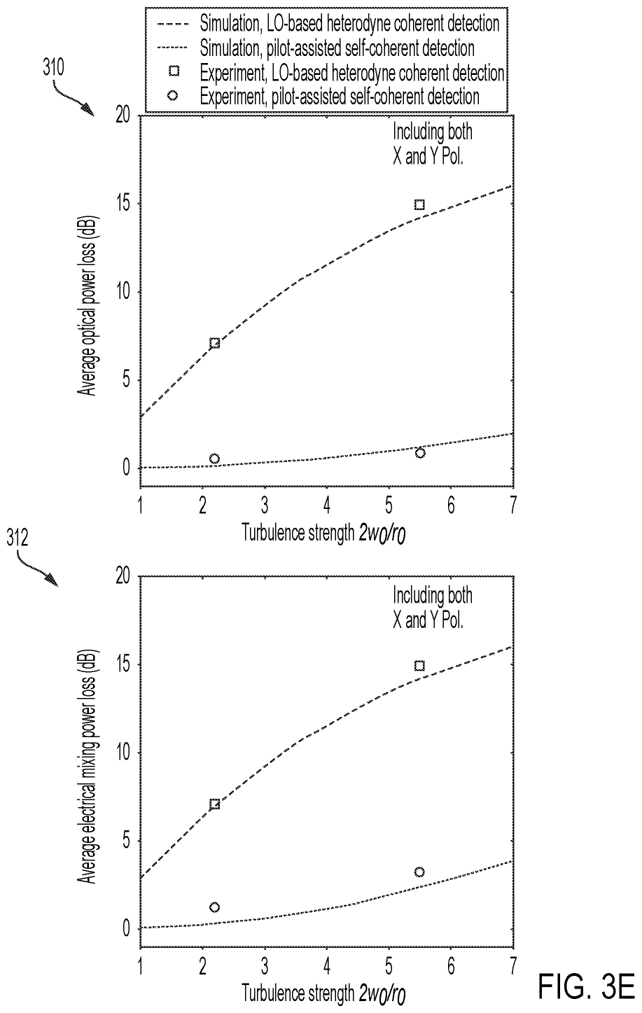

In connection with various embodiments, optical and electrical mixing power loss may be characterized. The turbulence-induced optical power loss and electrical mixing power loss of the pilot-assisted self-coherent detector is measured for each polarization at 1000 random realizations of emulated turbulence. With reference to FIGS. 3A-B for X polarization 302 and for Y polarization 304, stronger turbulence induces <2 dB optical power loss for self-coherent detection since the free-space PD can capture most of the power; and it may be noted that free-space-coupled IM/DD systems are likely to have similar captured-power loss. With reference to FIGS. 3C-D for X polarization 306 and Y polarization 308, the self-coherent detector has an electrical mixing power loss <3 and <6 dB for 99% weaker and 90% stronger turbulence realizations among 1000 random turbulence realizations, respectively. The relatively low mixing power loss for self-coherent detection is due to efficient mixing of the pilot and data beams that is likely to recover almost all the data power from the captured modes.

As discussed, turbulence-induced modal coupling can result in significant power loss for “mode-selective” SMF-coupled IM/DD or coherent detectors. FIGS. 3A-B show that optical power loss for SMF-coupled systems ranges from ˜2 to ˜22 dB and from ˜7 to ˜30 dB under ˜2.2 and ˜5.5 turbulence strengths, respectively. Among the 1000 emulated turbulence realizations, FIGS. 3C-D shows that the coherent detector can suffer from a mixing power loss of ˜28 dB for 99% and 90% of weaker and stronger turbulence, respectively. This mixing loss is due to the SMF-coupled detector not efficiently capturing power coupled to higher-order modes.

In order to help further validate the experimental results, this disclosure also includes simulation of the self-coherent system using 1-RPS. As shown in FIG. 3E, the simulation results indicate that self-coherent detection suffers <4 dB of average optical mixing power loss 310 and average electrical mixing power loss 312 as the turbulence strength 2w₀/r₀ from −1 to −7. Moreover, the plotted experimental results are generally in agreement with the simulation.

This disclosure also demonstrates 12-Gbit/s PolM FSO transmission under emulated turbulence effects, with each polarization carrying 1.5-Gbaud 16-QAM data. The transmitted total optical power per polarization (including pilot and data beams) is ˜7 dBm. The transmitted CSPRs are ˜1.1 and ˜1 for X and Y polarizations, respectively. The recovered 16-QAM constellations using the self-coherent detector under example realizations of the weaker and stronger turbulence demonstrate the performance of such systems and methods. One may measure the turbulence-induced LG spectra for 1 and p indices −5 to +5 and 0 to 10, respectively. The complex wavefront may be measured using off-axis holography.

With no turbulence effects, the pilot-assisted self-coherent detector can achieve near-error-free performance and recover error vector magnitudes (EVM)˜8% for the 16-QAM data. Under one example random realization of weaker turbulence, the data power is mainly coupled to the neighboring LG modes. Under two other random realizations of stronger turbulence, turbulence effects can induce a power loss >25 dB and power can be coupled coupling to a large number of LG modes. The performance of the self-coherent detector is not significantly affected by these turbulence effects, and the 16-QAM data can be recovered with EVMs from −8 to ˜10% for both realizations. This turbulence resiliency is due to the automatic modal-coupling compensation by the pilot-data mixing, enabling almost all captured LG modes to be efficiently recovered.

To elucidate the effects of turbulence-induced modal coupling on coherent detection, this disclosure also shows the recovered 16-QAM data for an SMF-coupled heterodyne coherent detector and that the recovered data quality degrades for both polarizations from EVMs ˜7.5% without turbulence to EVMs >16% for stronger turbulence. This degradation is due to data power coupled to higher-order modes that is not efficiently captured by the SMF.

The electrical spectra for the self-coherent and coherent detectors are also measured under these example turbulence realizations. Compared to the case of no turbulence, ˜3 and ˜18 dB SNR degradation of the IF signal are measured for self-coherent and coherent detectors, respectively.

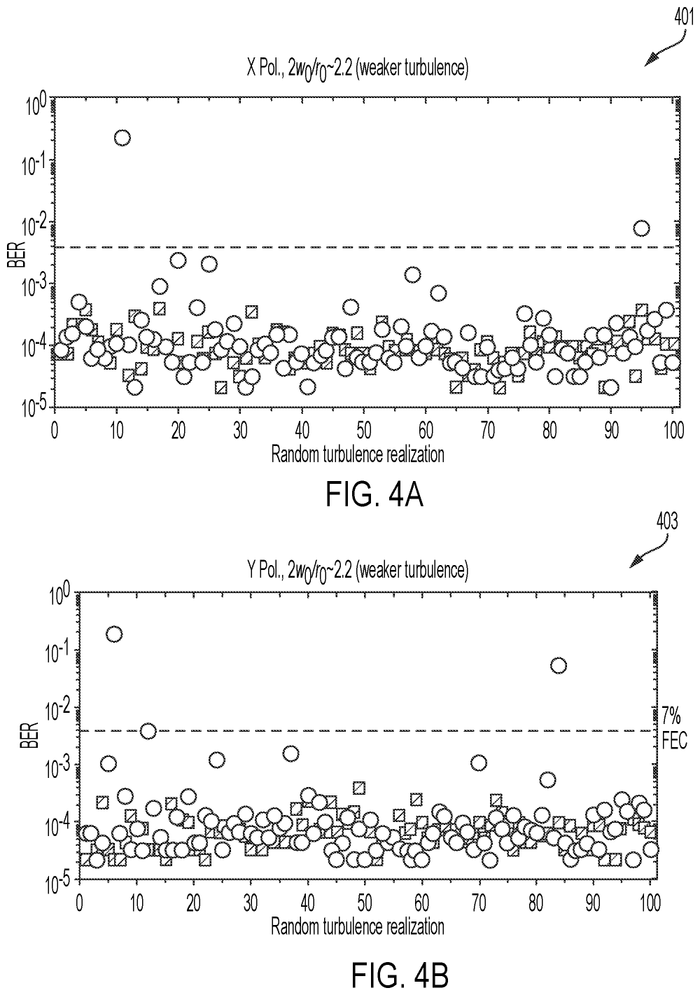

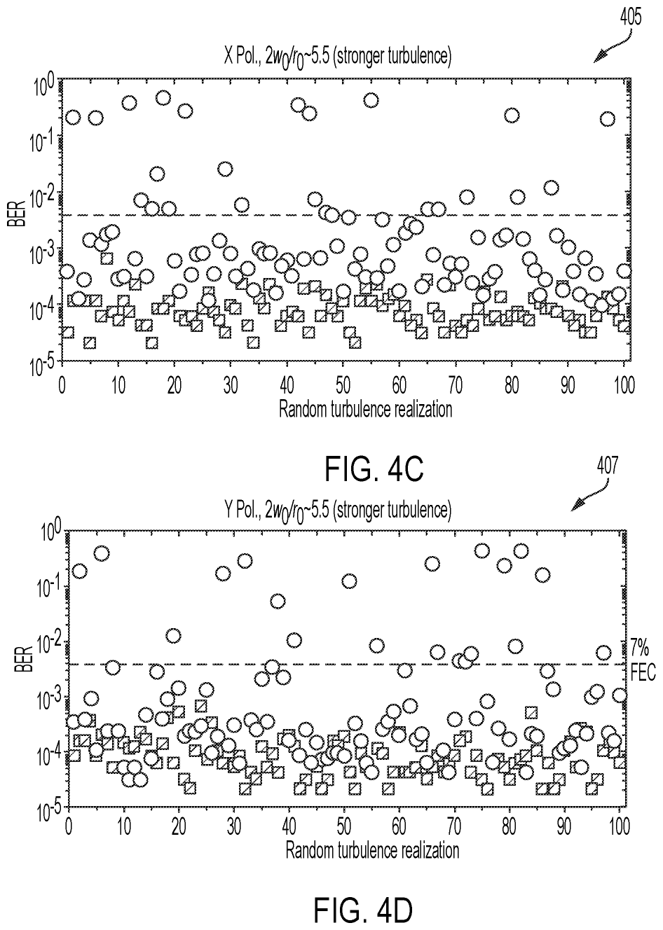

FIGS. 4A-4D show measured BERs for the pilot-assisted self-coherent detector under 200 random realizations of weaker and stronger turbulence. FIG. 4A shows a measured BER 401 for X polarization signals under weaker turbulence. FIG. 4B shows a measured BER 403 for Y polarization signals under weaker turbulence. FIG. 4C shows a measured BER 405 for X polarization signals under stronger turbulence. FIG. 4D shows a measured BER 407 for Y polarization signals under stronger turbulence. Results depicted in FIGS. 4A-4D show that the self-coherent detector can achieve BERs below the 7% forward-error-correction (FEC) limit for all realizations. Since turbulence can induce strong modal-coupling-induced power loss, the performance of the coherent detector can degrade and does not achieve the 7% FEC limit for some realizations.

One may further characterize the performance of the self-coherent detector by measuring the BER as a function of transmitted power. For instance, power penalties of ˜3 dB may be found for both polarizations under one example realization of the stronger turbulence.

In various embodiments, spectral efficiency may be enhanced using Kramers-Kronig detection. For various self-coherent approaches, a frequency gap between the pilot and data is implemented to avoid SSBI. This gap is roughly the data bandwidth, such that the spectrum is ˜2X the data bandwidth. However, this frequency gap can be reduced to increase spectral efficiency by using SSBI mitigation techniques, such as Kramers-Kronig (KK) detection. Therefore, this disclosure demonstrates reduction of the data-pilot gap to ˜0.1 GHz (IF−0.9 GHz) by using KK detection; the recovered 16-QAM data exhibit EVMs <12% for both polarizations under example realizations of weaker and stronger turbulence. Using KK, the spectral efficiency of the pilot-assisted approach may be increased by roughly 2X. Importantly, the KK scheme typically utilizes a stronger pilot than the non-KK approach. Hence, it is typically less power efficient than the non-KK pilot-assisted approach, resulting in a trade-off between power efficiency and spectral efficiency.

Further interesting issues may be considered. For instance, the 1.5 GHz baud rate may be limited by the PD's ˜3.5-GHz bandwidth. However, free-space-coupled PDs with a bandwidth of ˜49 GHz have been achieved, making possible >100 Gbit/s. Example embodiments utilize LG modes to analyze modal coupling. However, embodiments could utilize other bases (e.g., Hermite-Gaussian). Importantly, one does not need to specify a priori the employed basis because the approach is “automatic”, and the pilot and data can be described in different bases. Differential-phase-shift-keyed (DPSK) systems are also referred to as “self-coherent.” In DPSK: (a) data is typically encoded in the optical phase difference between neighboring symbols; (b) the received data beam is split into two copies of which one is delayed; (c) these copies are coherently combined in a Mach-Zehnder interferometer (MZI); and (d) both MZI output branches are detected by two PDs simultaneously to recover the differential-encoded data. Different from this pilot-assisted approach, almost all the captured optical power in DPSK systems contains data. Thus, one may appreciate that optical pilot beam 8 (FIG. 1) may be omitted in various embodiments. However, to recover QAM's amplitude and phase, differential systems typically utilize a more complex receiver than that of the pilot-assisted approach. Interestingly, various embodiments may utilize multi-mode mixing as described herein to achieve automatic turbulence resiliency in a differential, high-order QAM system.

Yet further interesting issues may be considered. For instance, a beam diverges with link distance. Consequently, both the data and pilot beams can suffer from truncation by a limited-size receiver aperture causing power loss for longer-distance links. Moreover, truncation can cause power coupling to higher-order modes. These higher-order modes tend to be automatically mixed by the pilot-assisted self-coherent detection since the pilot and data beams experience similar truncation effects. This disclosure utilizes a free-space PD. However, this approach may, in various embodiments, use fiber-coupled PDs. One possibility might be to use a multi-mode fiber-coupled PD such that many modes are captured and then impinge on the PD. Although FSO propagation is dependent on a beam's carrier frequency, it is likely that beam divergence and turbulence-induced spatial distortions are similar for the pilot and data beams. This is because their typical frequency difference (<1 nm) is significantly smaller than their carrier frequencies (˜1.55 μm). This disclosure has described the embodiments and experimental/simulation results of pilot-assisted self-coherent links to automatically mitigate modal coupling for recovering the data's amplitude and phase.

Various experimental methods have been implemented in connection with development of the embodiments provided herein. For instance, experiments with FSO communications in emulated turbulence have been performed. As shown in FIG. 1, there is a transmitted pair of data-carrying (optical data beam 6) and pilot (optical pilot beam 8) Gaussian beams on both X and Y polarizations. A 6-Gbit/s 16-QAM data channel at a wavelength of λ₁˜1.55 inn is generated, amplified by an erbium-doped fiber amplifier (EDFA), and equally split into two copies. One copy is delayed using a >15-m SMF to decorrelate the data channels and two independent data channels are individually combined with another pilot tone at a wavelength of λ₂ (with a frequency offset of ˜2.6 GHz from Δ₁, Δλ, ˜0.02 nm). The polarizations of signals and pilots are adjusted and subsequently combined by a polarization beam combiner to transmit PolM 16-QAM signals. The total optical power including the pilot and data beams is ˜7 dBm for each of the polarizations. The optical signal is coupled to free space by an optical collimator (Gaussian beam size in diameter 2w₀˜2.2 mm), is distorted by a rotatable turbulence emulator (see Methods section for more detail), and propagates in free space for ˜1 m. In this demonstration, different strengths of atmospheric turbulence are emulated by using two separate turbulence emulators with different Fried parameters r₀ of 1.0 mm and 0.4 mm. The emulated turbulence distortion for the transmitted Gaussian beam is characterized by the ratio of beam size over the Fried parameter, which are 2w₀/r₀˜2.2 and ˜5.5 for the two emulators.

At the receiver, one polarization may be demultiplexed at a time by using a half-wave plate (HWP) cascaded with a polarizer. The receiver has an aperture diameter of ˜10 mm. The spatial amplitude and phase profiles of the turbulence-distorted beam is measured, and its LG decomposition is calculated using the off-axis holography. After polarization demultiplexing, the distorted beam is equally split into two copies that are sent to the pilot-assisted self-coherent detector and a single-PD LO-based heterodyne coherent detector.

In the pilot-assisted self-coherent detector, the entire spatial profiles of the distorted data and pilot beams are focused into a free-space-coupled InGaAs PD (3-dB bandwidth <3.5 GHz) using an aspheric lens with a focal length and a numerical aperture (NA) of 16 mm and ˜0.79, respectively. The coupling efficiency of the received Gaussian beam, defined as the ratio of received optical power detected by the PD without turbulence effects, is measured to be >92%. The generated photocurrent is recorded by a real-time digital oscilloscope and the I-Q information of the data channel is subsequently retrieved by using off-line DSP algorithms. The Nyquist-shaped 16-QAM data channel has a symbol rate of 1.5 GHz with a roll-off factor of 0.1, expanding the data's spectrum to −1.7 GHz. To avoid the SSBI effects, the IF (i.e., difference between the pilot and data's carrier frequencies) may be set at Δf-2.6 GHz, which includes a frequency gap of ˜1.8 GHz between the pilot and data beam. Thus, the total transmitted pilot-assisted signal spectrum is ˜3.5 GHz, which is roughly 2 times that of the data spectrum.

At the single-PD LO-based heterodyne coherent detector (the pilot λ₂ is turned off), there is set the same IF value as the pilot-assisted self-coherent receiver. The distorted Gaussian beam is coupled into an SMF via a collimator (aperture diameter ˜3.5 mm), amplified by an EDFA, and mixed with an LO (at the same wavelength λ₂ as the pilot) at the SMF-coupled PD. The received optical signal is amplified by the EDFA to meet the power sensitivity requirement of the SMF-coupled PD. The electrical signal is subsequently recorded by a real-time digital oscilloscope and processed to retrieve the data channel's I-Q information by using the same off-line DSP algorithms as the pilot-assisted self-coherent detector. In FIG. 3E, measurements of the optical power loss 310 and electrical mixing power loss 312 of this detector are made without using the EDFA inside this receiver. The mixing power loss is measured at the IF of ˜2.6 GHz in the electrical domain.

To evaluate the effectiveness of the pilot-assisted self-coherent detector to various turbulence scenarios, the BER values of the 16-QAM data channels carried by both polarizations are measured over 200 random turbulence realizations. To measure turbulence-induced modal-power-coupling effects on an SMF-coupled coherent detector, the BER performance for the LO-based heterodyne coherent detector is also measured over 200 random turbulence realizations. Note that in some experiments, the BER performance is measured for one polarization at a time due to limitations of the measurement setup. Therefore, the BER values for X and Y polarizations with the same realization label may correspond to different turbulence realizations and are difficult to be directly compared.

This disclosure includes an experimental emulation of the turbulence-induced distortion by utilizing glass plates (LEXITEK, INC.) of which the refractive index distributions are fabricated to emulate Kolmogorov power spectrum statistics. Two rotatable glass plates are separately employed in the experiment with different Fried parameters r₀ of 1.0 mm (weaker turbulence effects) and 0.4 mm (stronger turbulence effects). Different “random” turbulence realizations are implemented by rotating the single glass plate to different orientations. The diameter of the transmitted Gaussian beam is 2w₀˜2.2 mm. The data-carrying Gaussian beams are distorted by the glass plate and then propagate in free space for a distance of ˜1 m before reaching the receiver. The strength of turbulence distortion is given by the ratio of beam diameter over the Fried parameter, i.e., 2w₀/r₀. For a proof-of-concept demonstration, an investigation is performed of the performance of the pilot-assisted self-coherent detector at two different turbulence strengths (2w₀/r₀˜2.2 and 5.5). Under even stronger turbulence effects, the self-coherent FSO systems may suffer from beam wandering effects and the resultant optical power loss. One may utilize a beam pointing and tracking system to compensate for these beam wandering effects.

In this demonstration, a single phase plate is utilized to emulate turbulence distortions for this ˜1-m FSO link. However, a multiple-phase-plate emulation can generally provide a higher accuracy for emulating the volume atmospheric turbulence effects. To illustrate the validity of the emulation method, one may simulate 1-RPS and 5-RPS turbulence effects and may find similar trends for turbulence-induced system degradations. One may note that the turbulence emulation provides an approximation of the Gaussian beam's propagation in a turbulent medium and may not fully reflect the effects of real atmospheric turbulence. To further enhance the accuracy of turbulence emulation, one could potentially apply some advanced modeling or emulation methods.

Off-axis holography is utilized to measure the complex wavefront (i.e., amplitude and phase) of the distorted Gaussian beam and its corresponding LG spectrum. An off-axis reference Gaussian beam (beam diameter ˜7 mm) on the same wavelength as the distorted pilot Gaussian beam is incident on the infrared camera with a tilted angle. The off-axis interferogram is recorded and digital image processing is applied to extract the complex wavefront. The data-carrying beam is turned off when measuring the complex wavefront of the turbulence-distorted pilot beam.

After the complex wavefront of the distorted Gaussian beam is obtained, it is decomposed it into a two-dimensional LG modal spectrum of which the two indices 1 and p range from −5 to +5 and from 0 to 10, respectively, as expressed in Eq. (7):

a_{l,p}=∫∫E_{rec}(x,y)·LG_{l,p}(x,y)dxdy,

where E_{rec}(x,y) and LG_{l,p}(x,y) are the measured complex field of the distorted Gaussian beam and the theoretical complex field of an LG_{l,p} mode, respectively. The ratio of optical power coupling to the LG_{l,p} mode is given by |a_{l,p}|².

In various embodiments, DSP is implemented for retrieving the I-Q information at a receiver. The detected electrical signal is sampled by a real-time oscilloscope (20-GHz bandwidth and 50-GSa/s sampling rate) and recorded for off-line DSP. The recorded signals from the pilot-assisted self-coherent detector and the single-PD LO heterodyne coherent detector are processed by the same DSP procedures. Each signal is filtered by a root-raised-cosine finite impulse response filter with a roll-off factor of 0.1, and the filtered signal is subsequently equalized using a constant modulus algorithm (CMA). After the CMA equalization, carrier frequency offset estimation and carrier phase recovery are sequentially performed to reduce the frequency and phase difference between the signal and the LO (or pilot). Finally, the EVM and BER of the demodulated signal are calculated to evaluate the quality of data transmission. The EVM of the detected signal is calculated using Eq. (8) as follows:

$$E V M = \sqrt{\frac{1}{N \cdot {max}_{i} {\vert \hat{{x}_{1}} \vert}^{2}} \cdot {\sum }_{i = 1}^{N} {\vert {x}_{i} - \hat{{x}_{1}} \vert}^{2}} \times 1 \; 00 \% , \qquad ( 8 )$$

where the xᵢ and [symbol] represent the transmitted and recovered data symbols, respectively; N is the total number of detected symbols. In this demonstration, ˜180,000 symbols are collected to calculate the EVMs and BERs of 16-QAM data signals.

In addition to addressing atmospheric turbulence, these systems and methods may also address misalignments (both lateral and angular) between transmitters and receivers. In free-space optical (FSO) communication links, an amplitude-modulated data beam is commonly transmitted and recovered. Alternatively, FSO systems can benefit from simultaneously recovering the data beam's amplitude and phase to enable complex modulation formats such as quadrature amplitude modulation (QAM). In general, QAM is likely to be less demanding in terms of optical signal-to-noise ratio as compared to amplitude-only modulations due to its larger Euclidean distance in the two-dimensional in-phase/quadrature constellation.

In general, recovering both the phase and amplitude-encoded data in FSO links can be quite challenging. An ideal FSO system can recover QAM by using coherent detection, which efficiently mixes the Gaussian data beam with a receiver (Rx)-based Gaussian local oscillator (LO) beam. However, one key challenge is that the transmitter and receiver apertures may not be fully aligned, which can be quite difficult for long distances. As a result, angular tilt or lateral displacement can induce modal coupling at the receiver. Specifically, a Gaussian data beam that is misaligned with respect to a receiver based on single-mode fiber (SMF)-coupled photodetector (PD) can induce significant power coupling from the fundamental Gaussian mode into higher-order modes. The power in the higher-order modes will not efficiently mix with the LO because of the modal mismatch between the data and LO beams.

The problem of coherent detection under such modal coupling is not only caused by misalignment but also by atmospheric turbulence. Turbulence-resilient pilot-assisted self-coherent FSO communication links are provided by using automatic optoelectronic mixing of many modes. From the transmitter (Tx), a Gaussian data beam together with a Gaussian pilot beam are coaxially sent through the turbulence, such that both beams experience similar turbulence-induced spatial distortion. At the receiver, a free-space PD is used to capture both beams, and a conjugate modal coupling of the pilot beam is automatically generated to compensate for the modal coupling in the data beam. This approach mitigates atmospheric turbulence when recovering phase and amplitude and is also applicable to misalignment tolerance.

This disclosure includes an experimental demonstration of enhanced misalignment tolerance for recovering phase and amplitude encoding in a pilot-assisted self-coherent FSO link. The experimental results show that (i) electrical mixing power of the data and LO for self-coherent receiver remains nearly unchanged with 0.12° angular- or 8-mm lateral misalignments (Tx beam waist=1.5 mm) and (ii) the approach recovers 1.5-Gbaud 16-QAM data with bit error rate (BER) below the 7% forward error correction (FEC) limit with <0.13° angular- or <9-mm lateral misalignments.

In an FSO link, the receiver can be misaligned with the transmitter due to improper setup and vibration. Thus, the transmitter and the receiver may have angular shifts (e.g., receiver angular error), or lateral misalignment between each other. Enhanced misalignment tolerance is available in pilot-assisted self-coherent FSO communications using a free-space PD. At the transmitter, a Gaussian data beam is transmitted coaxially with a pilot beam with a frequency offset. The misalignment of the receiver would induce similar modal coupling from the Gaussian mode to higher-order Laguerre-Gaussian (LG) modes to both data and pilot beams. Subsequently, both similarly distorted beams are mixed in a free-space PD. As almost all the LG modes of the data beam can mix with their counterparts in the pilot beam as LO, the misalignment-induced modal coupling is automatically compensated.

In an experimental setup for a self-coherent system, two lasers at 1550 nm with a frequency difference of ˜2.7 GHz are used to generate Gaussian beams with the same beam waist of 1.5 mm. After propagating for ˜1 m, a linear stage is used to induce lateral misalignment to the propagated beam. A grating pattern on a spatial light modulator (SLM) is used to induce angular misalignment. The SLM is imaged on the receiver by a 4-f system, so that the angular misalignment is applied to the received beam without lateral displacement. Both focusing lenses for the free-space PD and SMF have an aperture diameter of 25 mm, which can be regarded as the receiver aperture. An off-axis holography setup may also be provided for measuring intensity and phase profiles of the beams.

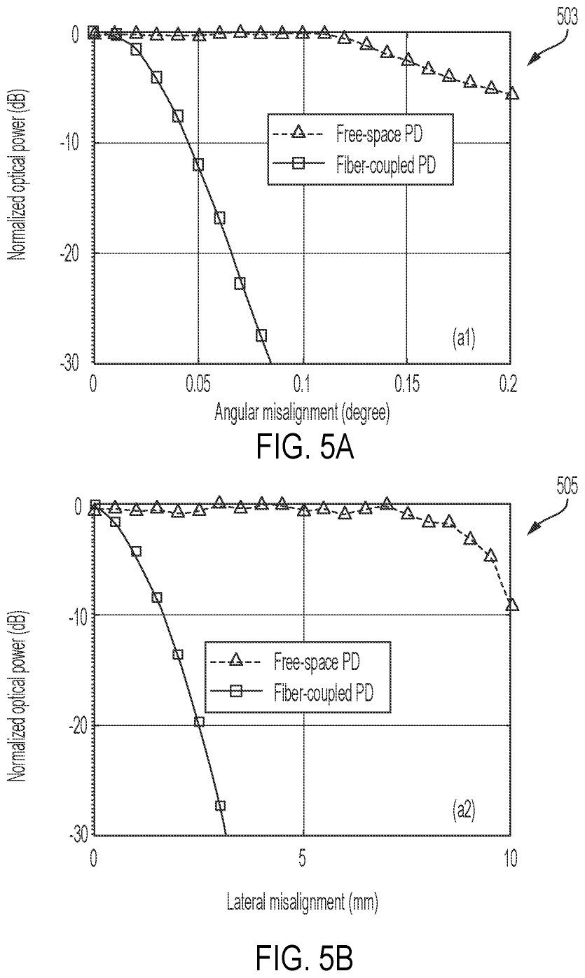

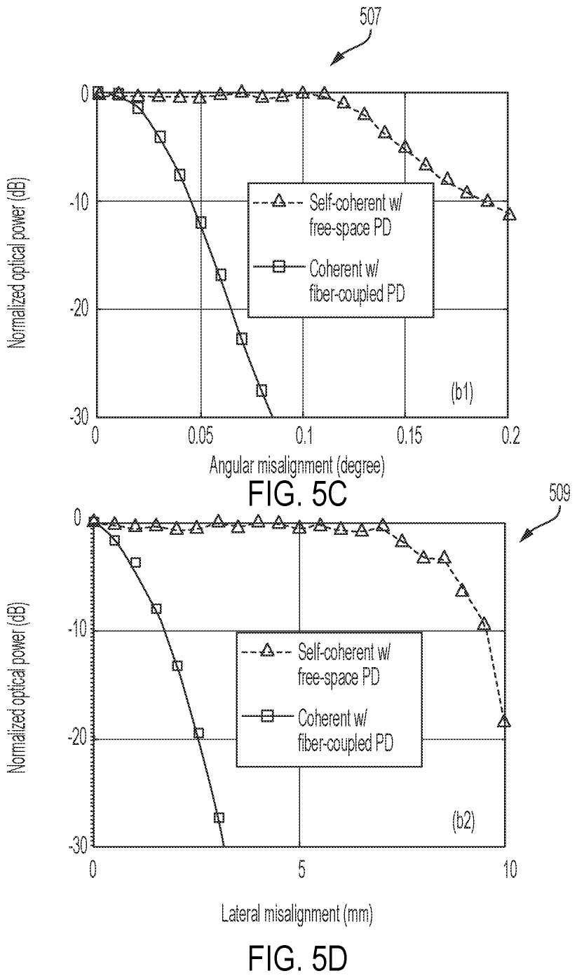

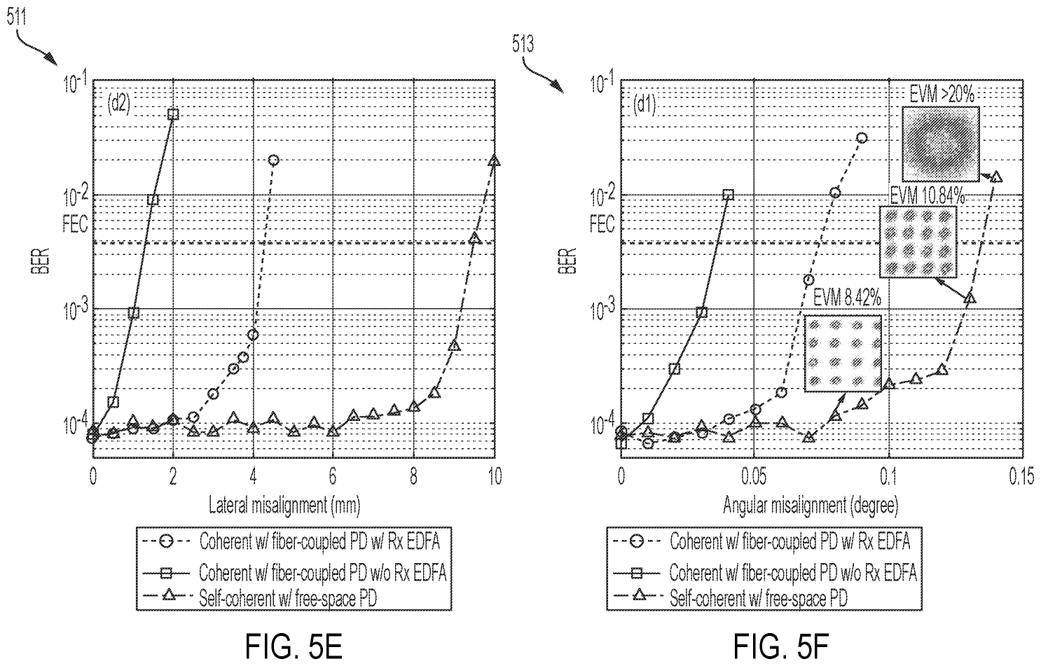

FIGS. 5A, 5B, 5C, and 5D show the experimental results of normalized received optical and electrical mixing power for free-space-coupled self-coherent and fiber-coupled coherent systems. For instance, FIG. 5A shows a chart 503 of normalized optical power for various angular misalignments. FIG. 5B shows a chart 505 of normalized optical power for various lateral misalignments. FIG. 5C shows a chart 507 of normalized electrical mixing power for various angular misalignments. FIG. 5D shows a chart 509 of normalized electrical mixing power for various lateral misalignments. With a fiber-coupled PD, both the received optical power and electrical mixing power decrease by ˜30 dB with the 0.08° angular- or 3-mm lateral misalignments. Such effects may be due to the misalignment-induced modal coupling and/or may be due to the fact that with the increase of the misalignment, the collimator-focused beam will have less overlap with the fiber core. However, for the self-coherent system, both powers remain nearly unchanged with 0.12° angular or 8-mm lateral misalignments. With the further increase of the misalignment, the power decreases. Such effects may, in various embodiments, be because (i) the lateral misaligned beam is truncated by the receiver aperture and (ii) the larger angular misalignment causes the focused beam to shift farther from the center of the PD sensing area and might be truncated. The power fluctuations in the measurement may be due to the residual misalignment and the resolution of the manual linear stage. The measured intensity and phase profiles of an angular or lateral misaligned beam also evaluated. The angular misalignment induces grating-like phase distortions to the received beam, and the lateral displacement shifts the position of the intensity and phase centers. Both types of misalignments induce modal power coupling from the transmitted Gaussian mode to neighboring higher-order [symbol] and p modes in the two-dimensional LG modal spectra.

We further measure the BER performance as a function of angular and lateral receiver misalignments. A 6-Gbit/s 16-QAM free-space link is achieved below the 7% FEC limit with both pilot-assisted self-coherent and fiber-coupled coherent receivers. Without the receiver EDFA, the coherent receiver can achieve BER below the FEC threshold with <0.04° angular- or <1.5-mm lateral misalignments. The receiver EDFA increases the sensitivity of the coherent system, resulting in BER values below the FEC limit for 0.07° angular- or 4-mm lateral misalignments. For the self-coherent receiver with free-space PD, since the misalignment-induced modal coupling is automatically compensated, the BER performance can be achieved below the 7% FEC threshold for up to 0.13° angular- or 9-mm lateral misalignments. FIG. 5E depicts a chart 511 of bit error rate (BER) for lateral misalignments. FIG. 5F depicts a chart 513 of bit error rate (BER) for angular misalignments.

Various embodiments also contemplate implementations for DPSK systems. Notably, in addition to QAM systems, various embodiments also contemplate a 2.25-Gbit/s DPSK free space optical link that also exhibits turbulence resilience when self-coherent automatic optoelectronic mixing of many spatial modes is implemented. An experimental demonstration shows a 2.25-Gbit/s DPSK free-space optical link that exhibits resilience to turbulence-induced modal coupling loss. The measured average mixing loss is ˜14.6-dB less than a single-mode-fiber-coupled system based on 200 random turbulence realizations.

Free-space optical (FSO) communications often use an amplitude-modulated data beam and direct detection by a single photodetector (PD), and the amplitude modulation can be binary (e.g., on-off keying) or M-ary. As with general optical communication systems, binary-phase-shift-keying (BPSK) tends to be less signal-to-noise-ratio (SNR) demanding than amplitude modulation. To recover the BPSK data, coherent detection with a local oscillator (LO) can be utilized. Moreover, in the scenario of direct detection for BPSK, the data can be differentially encoded (e.g., differential-phase-shift-keying, DPSK), and the receiver may include a delay-line interferometer (DLI) and a balanced PD.

One significant degrading effect for FSO systems is atmospheric turbulence since turbulence can couple the transmitted optical power from the fundamental Gaussian laser mode to many higher-order spatial modes, such as the Laguerre-Gaussian (LG) modes. For coherent-detected BPSK/DPSK data, the system would suffer from significant data-LO mixing loss due to the turbulence-induced spatial field mismatch; the single-mode LO is not likely to efficiently mix with the higher-order modes. With respect to the direct-detected DPSK, an SMF-coupled receiver would suffer from turbulence-induced modal coupling loss because the higher-order modes are poorly supported by the SMF itself.

A few-mode-fiber (FMF) amplifier cascaded with a free-space DLI and an FMF-coupled balanced PD can help increase the DPSK FSO system's resistance to turbulence distortion. A pilot-assisted self-coherent transmission scheme automatically compensates the turbulence-induced modal coupling loss for FSO systems. In that approach, the modal coupling is mitigated by optoelectronic (O/E) mixing between the similarly distorted pilot and data beams at a free-space-coupled PD. In addition, the automatic O/E multi-mode mixing can be applied to a power-efficient DPSK FSO link under different turbulence distortions.

In various instances, a 2.25-Gbit/s turbulence-resilient DPSK FSO link using automatic multi-mode O/E beam mixing is provided. A fundamental Gaussian laser beam carrying the DPSK data stream is transmitted in a ˜1-m FSO link with an emulated turbulence strength of 2ω₀/r₀˜5.5. At the receiver, a free-space DLI with relay imaging setups is utilized to enable spatial matching and coherently combining the direct beam and its 1-symbol-delayed copy. After focused onto free-space-coupled PDs, the turbulence-induced modal coupling is automatically compensated by the square-law data-data O/E mixing. Experimental results indicate that: (i) this approach exhibits an average mixing loss of ˜14.6-dB less than that of an SMF-coupled system (based on 200 random turbulence realizations), and (ii) the multi-mode O/E mixing achieves less quality (Q) factor variation than an SMF-coupled coherent receiver (based on 50 random turbulence realizations).

A fundamental Gaussian beam carrying DPSK data is transmitted through atmospheric turbulence. Due to the random refractive index distribution of turbulence, the receiver would capture a distorted beam containing many higher-order LG modes. In this approach, a free-space DLI with relay imaging is used to match and coherently combine the received field and the 1-symbol-delayed copy of itself, and subsequently both beams are focused onto free-space-coupled PDs. The PDs can perform automatic O/E multi-mode data-data differential mixing to efficiently recover the data stream: l(t)∝∫∫s(t)U·U*s(t−Tₛ)*dxdy≈s(t)·s(t−Tₛ)* where l(t) and s(t) are the generated photocurrent and transmitted DPSK data, respectively; and the turbulence-induced LG modal coupling U is automatically compensated by O/E mixing.

As such, a laser is modulated with a 2.25-Gbit/s DPSK data stream and coupled to free space (beam size 2ω₀˜2.2 mm), and normally incident on the turbulence emulator. The transmitted optical power is ˜6 dBm. Turbulence distortion is emulated by a rotatable glass phase plate with a fabricated Fried parameter r₀ of 0.4 mm. Different turbulence realizations are emulated by rotating the glass plate to random orientations. After ˜1-m free-space propagation, the distorted beam is captured by the receiver and an off-axis holography measures the wavefront and the corresponding LG spectrum of the distorted beam. At the receiver, a free-space DLI with two 4f relay imaging systems is designed to match the spatial fields between the direct and delayed beams. After coherent beam combining inside the DLI, two sets of distorted beams are focused onto separate free-space-coupled PDs (Thorlabs DET08C) and joint off-line digital signal processing is used to recover the DPSK data. To illustrate the effects of turbulence-induced modal coupling loss on an SMF-coupled system, we also measure the recovered data quality of an SMF-coupled coherent receiver.

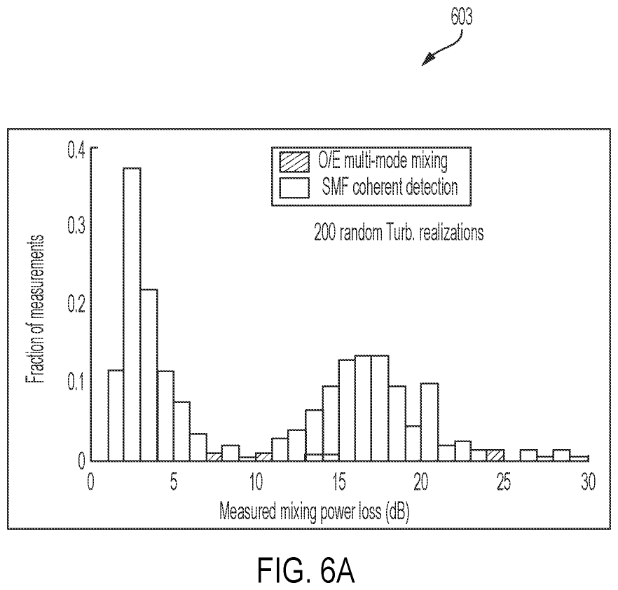

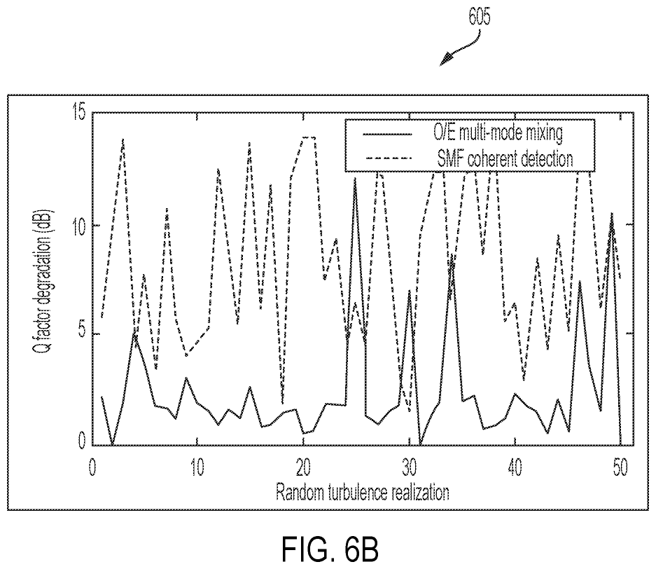

Referring now to FIG. 6A, a chart 603 of measured mixing power losses is depicted for the disclosed system versus for single-mode fiber (SMF). Such approach shows an average mixing loss of ˜4.6 dB for 200 random realizations while ˜19.3-dB average mixing loss for the SMF-coupled system. Referring now to FIG. 6B, a chart 605 of Q factor degradation for random turbulence realizations for the disclosed system versus single-mode fiber (SMF) is depicted. The multi-mode O/E mixing tends to have less Q factor variation (more resilient to turbulence-induced modal coupling loss) than the SMF-coupled coherent system over 50 random turbulence realizations.

Returning reference to FIG. 1, various preceding discussions describe a photodetector (PD) 16. However, various preceding embodiments may also include multiple photodetector elements, such that photodetector (PD) 16 comprises an array of multiple photodetectors.

As mentioned, atmospheric turbulence is a key limitation in free-space optical (FSO) communication systems. For amplitude-only data encoded systems, turbulence can cause scintillation and power loss. The challenge is perhaps far greater for phase-and-amplitude encoded high-modulation-format systems. This is because: (i) the data beam going through turbulence will have power coupled from the fundamental Gaussian mode into many higher-order spatial modes, and (ii) these higher-order spatial modes do not efficiently mix with a fundamental-Gaussian-mode local oscillator (LO) that is conventionally used for detecting phase-encoded data. A turbulence-resilient pilot-assisted self-coherent FSO communication link has been disclosed and implements automatic optoelectronic mixing of many modes. From the transmitter, an additional Gaussian pilot beam with a frequency offset may be sent coaxially with the Gaussian data beam, such that both beams experience similar turbulence-induced modal coupling. At the receiver, both beams may be captured by a free-space detector and a conjugate modal coupling of the pilot beam is automatically generated to compensate for the modal coupling in the data beam. Therefore, the beams are efficiently mixed and the amplitude and phase of the data (e.g., 16-QAM) can be recovered.

The above approach uses a free-space detector to efficiently mix the corresponding pairs of higher-order modes between the data and pilot beams. Typically, receivers that detect phase and amplitude encoding with a local oscillator use a photodetector (PD) coupled with single-mode fiber. As mentioned, higher-order modes do not couple efficiently into a single-mode fiber, but it is important to note that fiber-coupled detectors can typically be smaller and higher bandwidth than free-space detectors. Therefore, in various instances, systems and methods are provided to increase the bandwidth of the free-space detector and still preserve the automatic turbulence resilience due to mode mixing. Thus, in various instances, photodetector 16 comprises an array of multiple photodetector elements. By incorporating multiple relatively smaller photodetector elements (PDs) rather than a single PD, overall bandwidth may be increased.

In this disclosure, an experimental demonstration is provided of a pilot-assisted turbulence resilient self-coherent FSO communication link using an array of smaller PDs for bandwidth enhancement. The experimental results show that (i) under 100 turbulence realizations (D/r₀=˜8.4), the pilot-assisted self-coherent PD-array receiver recovers 1-Gbaud 16-QAM data with the bit error rate (BER) below 7% forward error correction (FEC) limit and (ii) either without and with turbulence effects, the 1-Gbaud 16-QAM data constellation recovered by the array of smaller PDs has lower error vector magnitude (EVM) than that of single larger PD.

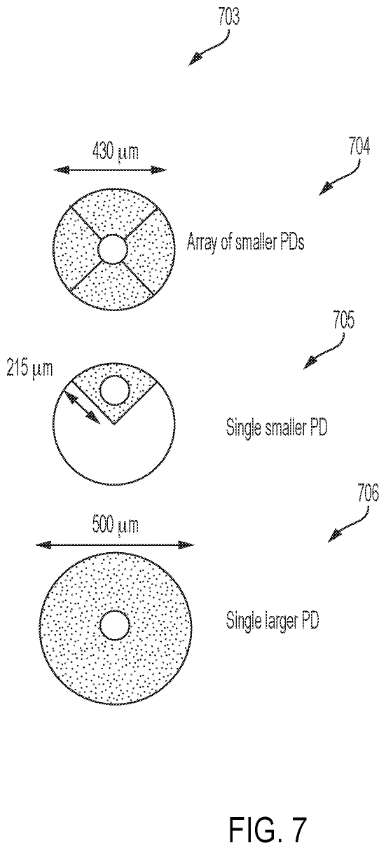

FIG. 1 shows an example embodiment of turbulence resilient pilot-assisted self-coherent FSO communications using an array of smaller PDs (photodetector(s) 16). At a transmitter, the Gaussian data beam is sent together with a coaxial Gaussian pilot beam with a frequency offset. Experiencing similar turbulence-induced distortion, the two beams have similar modal coupling to higher-order LG_{l,p} modes. The indices l and p of a 2-dimensional LG_{l,p} spatial modal set represent the beam's spatial distributions along the azimuthal and radial directions, respectively. At the receiver, the similarly distorted data and pilot beams are coupled together into the PD array. In each PD, the truncated multi-mode pilot beam is mixed efficiently with the similarly truncated multi-mode data beam. By combining the output of the PDs, almost all the LG modes of data beam mix with the pilot beam as LO, and thus the turbulence-induced modal coupling is automatically compensated. Subsequently, the amplitude and phase information of the data can be recovered. In addition, with a similar total receiving area, the larger PD and the array of smaller PD could capture a similar amount of spatial modes while the array of smaller PD tends to generally support a larger bandwidth. FIG. 7 depicts a chart 703 of different relative sizes and configurations of photodetectors (photodetector(s) 16).

An experimental setup of an FSO link through emulated turbulence has been demonstrated. The setup experimentally emulates the turbulence-induced distortion by utilizing rotatable thin glass plates whose refractive index distributions are according to Kolmogorov spectrum statistics. By using a retroreflector, the beam propagates through two independent areas of the turbulence plate and thus experiences a relatively stronger turbulence distortion (r₀˜0.26 mm). The setup includes transmitting a pair of data-carrying and pilot beams with a beam size of 2.2 mm. A 16-QAM data channel at a wavelength of 1550 nm is generated. The pilot tone at a wavelength of λ₂ with a frequency offset with a range from −0.8 GHz to −2.6 GHz compared to λ₁. At the receiver side, a flip mirror is used to control the path of the optical beam towards different detectors. The size of the PDs we used in the experiment is shown chart 703 (FIG. 7). The amplitude and phase profiles of the beam are measured by off-axis holography.

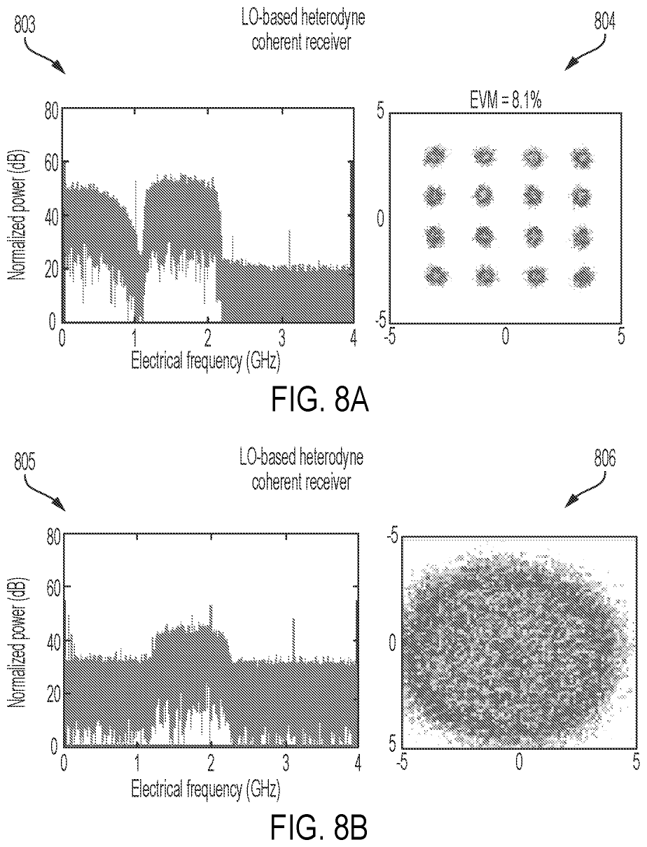

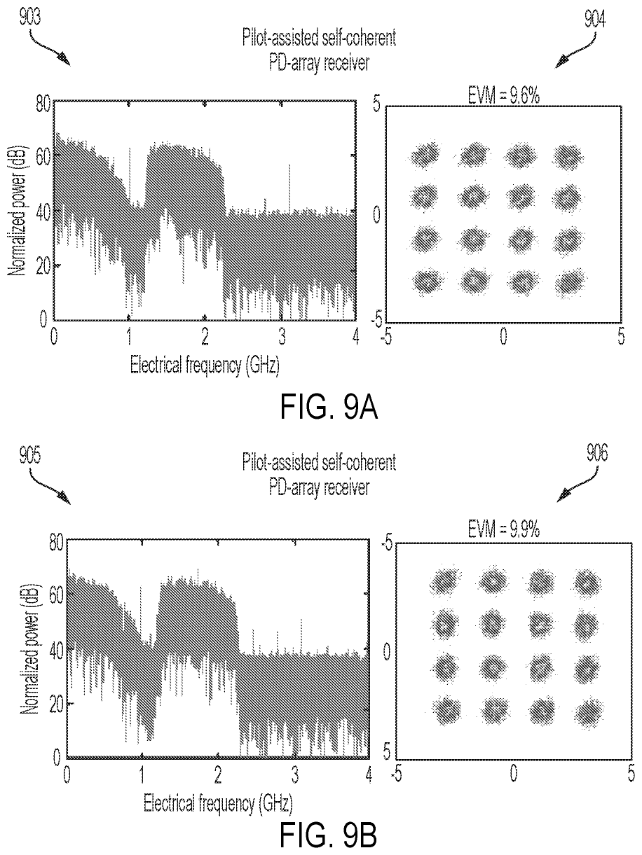

In various embodiments, the measured amplitude and phase profile of the transmitted Gaussian beam without turbulence effects has been evaluated. The measured LG spectrum shows that there is little modal power coupling to higher-order spatial modes. Without turbulence effects, both the LO-based heterodyne coherent receiver and self-coherent PD-array receiver can recover an EVM of 8%-9% for the 1-Gbaud 16-QAM data. For example, FIG. 8A depicts an electrical spectrum 803 shown as a chart of normalized power (dB) vs electrical frequency (GHz) for a LO-based heterodyne coherent receiver with no interference as well as the recovered 16-QAM data constellation 804 and FIG. 9A depicts an electrical spectrum 903 shown as a chart of normalized power (dB) vs electrical frequency (GHz) for a pilot-assisted self-coherent PD array receiver with no interference as well as the recovered 16-QAM data constellation 904.

In contrast, with turbulence effects, the amplitude and phase profiles of the transmitted Gaussian beam are distorted, and the power is coupled to a large number of modes. Under such turbulence realization, the power of the data beam cannot be efficiently coupled to SMF and the transmitted 16-QAM data fails to be recovered by the LO-based heterodyne coherent receiver as shown in FIG. 8B. FIG. 8B depicts an electrical spectrum 805 shown as a chart of normalized power (dB) vs electrical frequency (GHz) for a LO-based heterodyne coherent receiver with interference as well as the recovered 16-QAM data constellation 806. In contrast, FIG. 9B depicts an electrical spectrum 905 shown as a chart of normalized power vs electrical frequency for a pilot-assisted self-coherent PD array receiver with interference as well as the recovered 16-QAM data constellation 906.

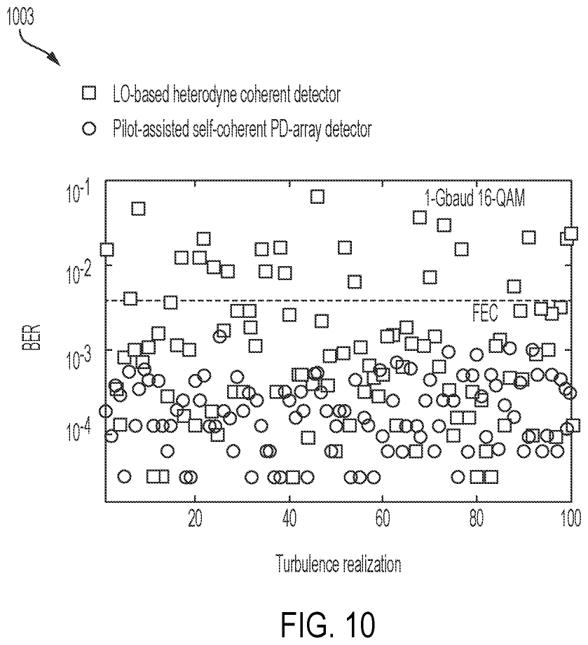

A comparison of FIGS. 9A-B with FIGS. 8A-B shows that the performance of the pilot-assisted self-coherent PD-array receiver is not severely affected by interference as the performance of the LO-based heterodyne coherent receiver and the 16-QAM data is recovered with an EVM of 9.9%. FIG. 10 depicts a chart 1003 that shows the measured BERs for the LO-based heterodyne coherent detector and for the pilot-assisted self-coherent PD array detector under 100 turbulence realizations. The PD-array receiver can achieve BER values below the 7% FEC limit for all realizations.

Furthermore, measured electrical spectra can be illustrated for a variety of different baud rates for different free-space PD configurations with and without turbulence. Such spectra illustrates the improved performance of pilot-assisted self-coherent PD receivers vs LO-based heterodyne coherent receivers and further illustrates the performance enhancement associated with implementing a photodetector (PD) that includes an array of smaller photodetector elements, rather than one large photodetector element.

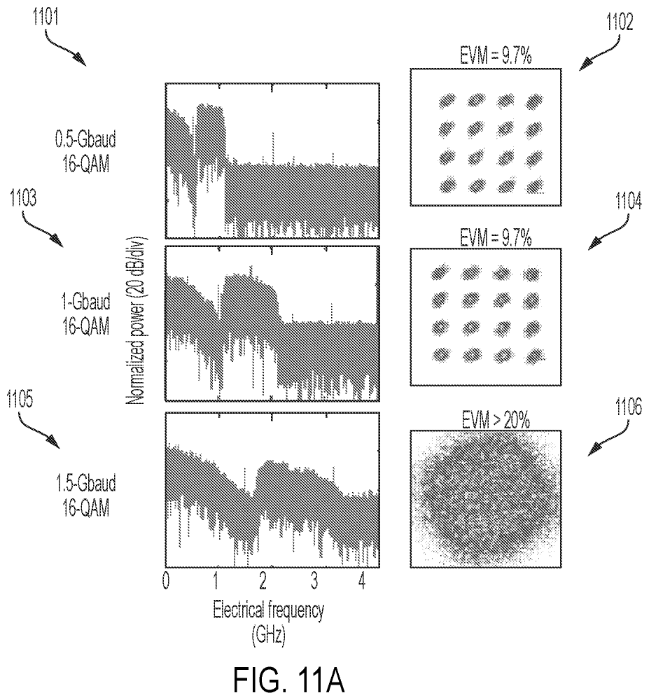

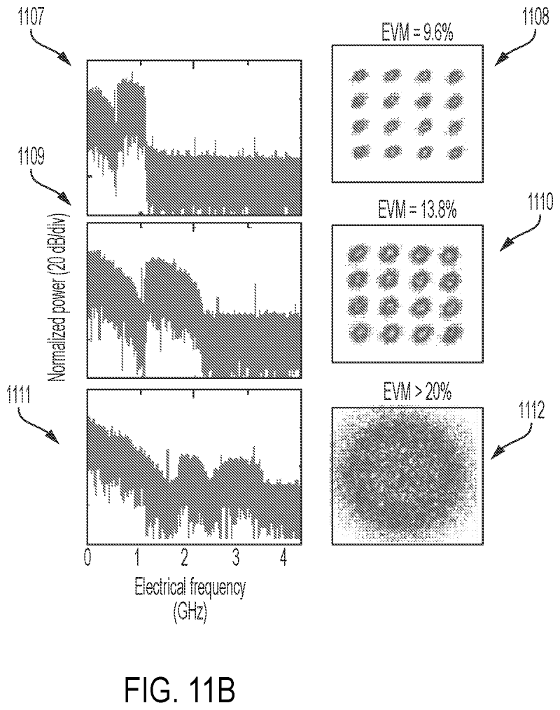

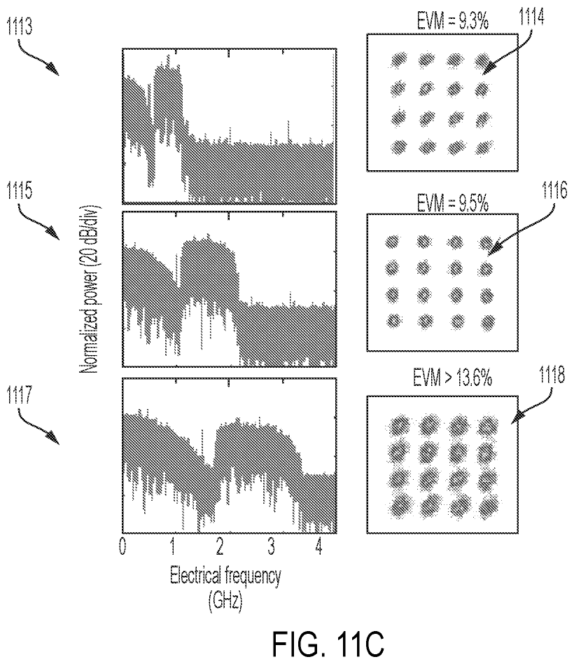

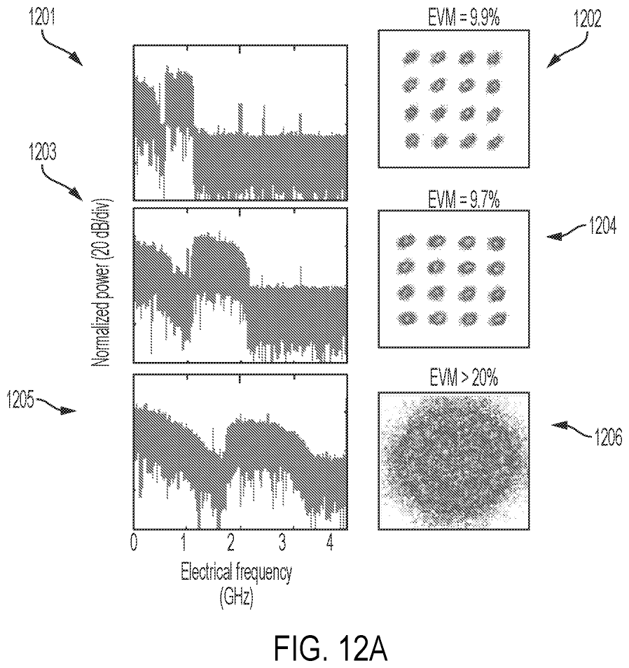

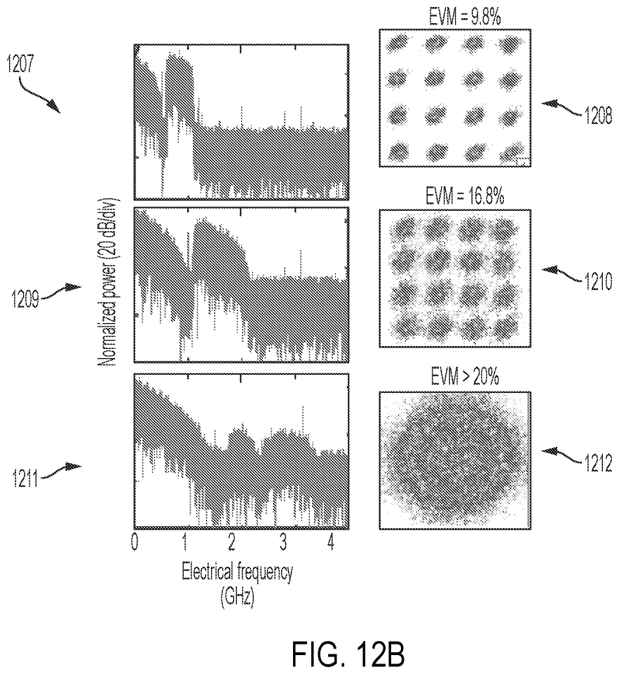

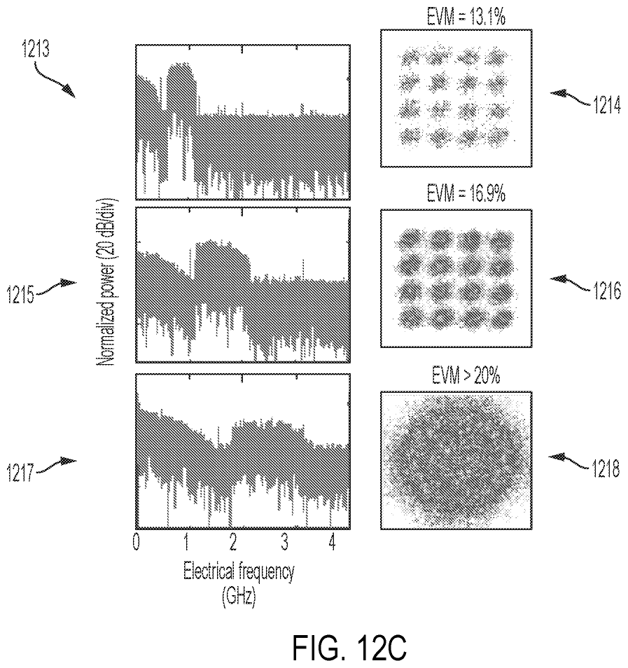

For instance, FIGS. 11A-12C show the measured electrical spectra and recovered 16-QAM data constellations with different baud rates for different free-space PDs. FIG. 11A shows, for a scenario without turbulence and using a PD having an array of smaller PD elements (PD 704, FIG. 7), an electrical spectrum 1101 for 0.5-Gbaud 16-QAM and the recovered 16-QAM data constellation 1102, an electrical spectrum 1103 for 1-Gbaud 16-QAM and the recovered 16-QAM data constellation 1104, and an electrical spectrum 1105 for 1.5-Gbaud 16-QAM and the recovered 16-QAM data constellation 1106. Each electrical spectrum is shown as a chart of normalized power (20 dB/div) vs electrical frequency (GHz).

FIG. 11B shows, for a scenario without turbulence and using a PD having a single larger PD elements (PD 706, FIG. 7), an electrical spectrum 1107 for 0.5-Gbaud 16-QAM and the recovered 16-QAM data constellation 1108, an electrical spectrum 1109 for 1-Gbaud 16-QAM and the recovered 16-QAM data constellation 1110, and an electrical spectrum 1111 for 1.5-Gbaud 16-QAM and the recovered 16-QAM data constellation 1112. Each electrical spectrum is shown as a chart of normalized power (20 dB/div) vs electrical frequency (GHz).

FIG. 11C shows, for a scenario without turbulence and using a PD having a single smaller PD element (PD 705, FIG. 7), an electrical spectrum 1113 for 0.5-Gbaud 16-QAM and the recovered 16-QAM data constellation 1114, an electrical spectrum 1115 for 1-Gbaud 16-QAM and the recovered 16-QAM data constellation 1116, and an electrical spectrum 1117 for 1.5-Gbaud 16-QAM and the recovered 16-QAM data constellation 1118. Each electrical spectrum is shown as a chart of normalized power (20 dB/div) vs electrical frequency (GHz).

FIG. 12A shows, for a scenario with turbulence and using a PD having an array of smaller PD elements (PD 704, FIG. 7), an electrical spectrum 1201 for 0.5-Gbaud 16-QAM and the recovered 16-QAM data constellation 1202, an electrical spectrum 1203 for 1-Gbaud 16-QAM and the recovered 16-QAM data constellation 1204, and an electrical spectrum 1205 for 1.5-Gbaud 16-QAM and the recovered 16-QAM data constellation 1206. Each electrical spectrum is shown as a chart of normalized power (20 dB/div) vs electrical frequency (GHz).

FIG. 12B shows, for a scenario with turbulence and using a PD having a single larger PD elements (PD 706, FIG. 7), an electrical spectrum 1207 for 0.5-Gbaud 16-QAM and the recovered 16-QAM data constellation 1208, an electrical spectrum 1209 for 1-Gbaud 16-QAM and the recovered 16-QAM data constellation 1210, and an electrical spectrum 1211 for 1.5-Gbaud 16-QAM and the recovered 16-QAM data constellation 1212. Each electrical spectrum is shown as a chart of normalized power (20 dB/div) vs electrical frequency (GHz).

FIG. 12C shows, for a scenario with turbulence and using a PD having a single smaller PD element (PD 705, FIG. 7), an electrical spectrum 1213 for 0.5-Gbaud 16-QAM and the recovered 16-QAM data constellation 1214, an electrical spectrum 1215 for 1-Gbaud 16-QAM and the recovered 16-QAM data constellation 1216, and an electrical spectrum 1217 for 1.5-Gbaud 16-QAM and the recovered 16-QAM data constellation 1218. Each electrical spectrum is shown as a chart of normalized power (20 dB/div) vs electrical frequency (GHz).

Without turbulence effects, the array of smaller PDs, single larger PD, and single smaller PD can recover 0.5-Gbaud 16-QAM data constellations. When the baud rate increases to 1 Gbaud, the data recovered from a single larger PD degrades due to its bandwidth. When the baud rate increases to 1.5 Gbaud, the array of smaller PDs fails to recover the data constellation. This could be potentially due to different frequency response (especially at higher frequency) of the PD-array photodiodes and combining the output of multiple PDs could lead to the decreased signal-to-noise ratio. With turbulence effects, single smaller PDs have degraded data constellation of 0.5-Gbaud 16-QAM data while the array of smaller PDs and single larger PD show similar EVM performance, as in the cases without turbulence effects. This could be because the single smaller PD tends to recover a smaller amount of spatial modes, thereby showing larger data degradation with turbulence effects. When the baud rate increases to 1 Gbaud, the data recovered by the array of smaller PDs show lower EVM than that of the lower bandwidth single larger PD.

Thus, one may appreciate that FIG. 1 encompasses various configurations, such as QAM and PSK modulation schemes, mechanisms for resiliency against both atmospheric turbulence and transmitter-receiver misalignments, as well as arrangements of the photodetector(s) 16, such as is illustrated in FIG. 7.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for free space optical (FSO) communications, the method comprising:
transmitting, by a transmitter, an optical data beam containing data and an optical pilot beam, the optical data beam and the optical pilot beam being transmitted over free space;
receiving, by at least one photodetector, the optical data beam and the optical pilot beam; and
compensating for optical distortions between the transmitter and the at least one photodetector using a conjugate of the received optical pilot beam.

2. The method of claim 1 wherein the optical pilot beam is transmitted coaxially with the optical data beam.

3. The method of claim 1 wherein the optical pilot beam is used as a local oscillator.

4. The method of claim 1 wherein a frequency difference between the optical data beam and the optical pilot beam is orders of magnitude smaller than carrier frequencies of the optical data beam and the optical pilot beam.

5. The method of claim 1 wherein the optical pilot beam is a continuous wave signal.

6. The method of claim 1 wherein compensating for the optical distortions includes mixing each Laguerre-Gaussian component of the optical data beam with a corresponding conjugate Laguerre-Gaussian component of the optical pilot beam.

7. The method of claim 1 wherein the at least one photodetector comprises an array of multiple photodetector elements.

8. A system for free space optical (FSO) communications, the system comprising:
a transmitter configured to transmit an optical data beam containing data and an optical pilot beam, the optical data beam and the optical pilot beam being transmitted over free space;
at least one photodetector configured to receive the optical data beam and the optical pilot beam; and
a processor connected to the at least one photodetector and configured to compensate for optical distortions between the transmitter and the at least one photodetector by using a conjugate of the received optical pilot beam to cancel distortions in the received optical data beam.

9. The system of claim 8, wherein the optical pilot beam is transmitted coaxially with the optical data beam.

10. The system of claim 8, wherein the optical pilot beam is used as a local oscillator.

11. The system of claim 8, wherein a frequency difference between the optical data beam and the optical pilot beam is orders of magnitude smaller than carrier frequencies of the optical data beam and the optical pilot beam.

12. The system of claim 8, wherein the optical pilot beam is a continuous wave signal.

13. The system of claim 8, wherein compensating for the optical distortions includes mixing each Laguerre-Gaussian component of the optical data beam with a corresponding conjugate Laguerre-Gaussian component of the optical pilot beam.

14. A system for free space optical (FSO) communications, the system comprising:
at least one photodetector configured to receive an optical data beam containing data and an optical pilot beam, the optical data beam and the optical pilot beam having traveled through free space; and
a processor connected to the at least one photodetector and configured to compensate for optical distortions introduced in the free space by using a conjugate of the received optical pilot beam to cancel distortions in the received optical data beam.

15. The system of claim 14, further comprising a transmitter configured to transmit the optical data beam and the optical pilot.

16. The system of claim 14, wherein the optical pilot beam is transmitted coaxially with the optical data beam.

17. The system of claim 14, wherein the optical pilot beam is used as a local oscillator.

18. The system of claim 14, wherein the at least one photodetector comprises an array of multiple photodetector elements.

19. The system of claim 14, wherein the optical pilot beam is a continuous wave signal.

20. The system of claim 14, wherein compensating for the optical distortions includes mixing each Laguerre-Gaussian component of the optical data beam with a corresponding conjugate Laguerre-Gaussian component of the optical pilot beam.
